(19) United States
(12) Patent Application Publication
(10) Pub. No.: US 2024/0261832 A1
(43) Pub. Date: Aug. 8, 2024

(54) HYBRID FOOD CYCLER SYSTEM HAVING INDEPENDENT PROCESSING COMPARTMENTS

(71) Applicant: Food Cycle Science Corporation, Cornwall (CA)

(72) Inventors: Meng Wang, Ottawa (CA); Timothy Maxwell, Stittsville (CA); Paul Auger, Osgoode (CA); Manoj Subramaniam, Nepean (CA); Bradley Crepeau, Ottawa (CA)

(73) Assignee: Food Cycle Science Corporation, Cornwall, ON (CA)

(21) Appl. No.: 18/430,989

(22) Filed: Feb. 2, 2024

Related U.S. Application Data
(60) Provisional application No. 63/483,388, filed on Feb. 6, 2023.

(51) Int. Cl. B09B 3/35; B09B 101/70

(52) U.S. Cl. CPC B09B 3/35; B09B 2101/70

(57) ABSTRACT

A hybrid system includes multiple food cycler system that each operate independently. A method of using the hybrid system includes receiving first food waste into a first removable bucket, receiving the first removable bucket into a first processing compartment, starting the first processing compartment to process the first food waste at a first time, receiving second food waste into a second removable bucket, receiving the second removable bucket into a second processing compartment and starting the second processing compartment to process the second food waste at a second time. The first processing compartment and the second processing compartment are configured in a same physical system and the first processing compartment and the second processing compartment each process respectively the first food waste and the second food waste using independent processes and at least one shared resource.

### PRIORITY CLAIM

The present application claims priority to U.S. Provisional Application No. 63/483,388, filed on Feb. 6, 2023, the contents of which are incorporated herein by reference.

### CROSS-REFERENCE TO RELATED APPLICATIONS

The present application is related to U.S. application Ser. No. 17/404,017, filed on Aug. 17, 2021, the contents of which are incorporated herein by reference.

### FIELD OF THE INVENTION

This disclosure introduces a hybrid food cycler system in which two or more food processing compartments are configured in the same overall system such that food waste provided to respective buckets can be independently processed by the hybrid food cycler system. The two or more food processing compartments also include two or more buckets with a volumetric efficiency relative to a volume of the overall system of about 0.106.

### BACKGROUND

Food cyclers are becoming popular for obvious reasons. People prefer to process their waste food rather than adding it to other trash. Some food cyclers are developed for use in homes or businesses and are often smaller in size given the non-commercial environment or in some cases where a small business uses a food cycler, the volume of waste food does not require a larger commercial unit. In normal use, it can be difficult to time the food cycling process in a batch mode where a bucket is filled at an appropriate time for placing into a food cycler to process the food.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

This disclosure describes a number of features of a new food cycler system consisting of two or more processing compartments each having a respective removable bucket and/or processing components and can independently process batches of food waste. The available volume of the two or more buckets relative to the volume of the overall system can be about 0.106 to provide volumetric efficiency. Furthermore, the independent processing enables the system to be used essentially continuously in environments such as restaurants.

In one aspect, a system includes a first processing compartment for receiving a first bucket of first waste food, at least one controller, a second processing compartment for receiving a second bucket of second waste food, wherein the at least one controller controls, via the first processing compartment, a first food recycling process for the first waste food and controls, via the second processing compartment, a second food recycling process for the second waste food, and at least one heat pump system that processes first humid air from the first processing compartment and second humid air from the second processing compartment. In some aspects, a single controller can control both processing compartments. In some aspects, the at least one heat pump can include a compressor, an evaporator and two or more separated condensers. Each of the two or more condensers can be associated with a respective processing compartment. In some aspects, at least one condenser configured with the at least one heat pump can be exposed to ambient air to add or remove heat from the system.

In one aspect, a method includes receiving first food waste into a first removable bucket, receiving the first removable bucket into a first processing compartment, starting the first processing compartment to process the first food waste at a first time, receiving second food waste into a second removable bucket, receiving the second removable bucket into a second processing compartment, starting the second processing compartment to process the second food waste at a second time, where the first processing compartment and the second processing compartment are configured in a same physical system and where the first processing compartment and the second processing compartment each process respectively the first food waste and the second food waste using independent processes, but use shared resources. Example resources can be any of the components disclosed herein such as a heat pump or any sub-system thereof, a condenser, a power supply, a filter, a controller such as a master controller or control system, a drainage port, or any other component or group of components.

In one aspect, a non-transitory computer-readable storage medium, the computer-readable storage medium including instructions that when executed by a computer, cause the computer to receive first food waste into a first removable bucket, receive the first removable bucket into a first processing compartment, start the first processing compartment to process the first food waste at a first time, receive second food waste into a second removable bucket, receive the second removable bucket into a second processing compartment, start the second processing compartment to process the second food waste at a second time, where the first processing compartment and the second processing compartment are configured in a same physical system and where the first processing compartment and the second processing compartment each process respectively the first food waste and the second food waste using independent processes and/or with at least one shared component or resources.

In one aspect, a computing apparatus includes a processor. The computing apparatus also includes a memory storing instructions that, when executed by the processor, configure the apparatus to receive first food waste into a first removable bucket, receive the first removable bucket into a first processing compartment, start the first processing compartment to process the first food waste at a first time, receive second food waste into a second removable bucket, receive the second removable bucket into a second processing compartment, start the second processing compartment to process the second food waste at a second time, where the first processing compartment and the second processing compartment are configured in a same physical system and where the first processing compartment and the second processing compartment each process respectively the first food waste and the second food waste using independent processes and/or with at least one shared component or resources.

One example system can include a first processing compartment for receiving a first bucket of first waste food; a second processing compartment for receiving a second bucket of second waste food; and at least one heat pump system that processes first humid air from the first processing compartment and second humid air from the second processing compartment wherein the first processing compartment and the second processing compartment recycle the first waste food and the second waste food on independent recycling processes.

In another aspect, a system can include a first processing compartment for receiving a first bucket of first waste food; a first controller for controlling, via the first processing compartment, a first food recycling process for the first waste food; a second processing compartment for receiving a second bucket of second waste food; a second controller for controlling, via the second processing compartment, a second food recycling process for the second waste food; and at least one heat pump system that processes first humid air from the first processing compartment and second humid air from the second processing compartment.

Another example can be a hybrid multiple food cycler system that includes a housing having a first volume; a first processing compartment for receiving a first bucket of first waste food, the first processing compartment configured within the housing; a first controller for controlling, via the first processing compartment, a first food recycling process for the first waste food; a second processing compartment for receiving a second bucket of second waste food, the second processing compartment configured within the housing and wherein a second volume is associated with both the first bucket and the second bucket; a second controller for controlling, via the second processing compartment, a second food recycling process for the second waste food; and at least one heat pump system configured within the housing and that processes first humid air from the first processing compartment and second humid air from the second processing compartment. A volumetric efficiency ratio between the second volume (the overall bucket volume) and the first volume (the overall system volume) can be about 0.106.

In another example, a food cycler system includes a housing having a first volume; a first processing compartment for receiving a first bucket of first waste food, the first processing compartment configured within the housing; a controller for controlling, via the first processing compartment, a first food recycling process for the first waste food and a second processing compartment for receiving a second bucket of second waste food, the second processing compartment configured within the housing and wherein a second volume is associated with both the first bucket and the second bucket. The controller can control, via the second processing compartment, a second food recycling process for the second waste food. The food cycler system can include at least one heat pump system configured within the housing and that processes first humid air from the first processing compartment and second humid air from the second processing compartment.

In some aspects, a system can include a first processing compartment for receiving a first bucket of first waste food; a second processing compartment for receiving a second bucket of second waste food; at least one controller for controlling, via the first processing compartment, a first food recycling process for the first waste food and controlling, via the second processing compartment, a second food recycling process for the second waste food; and at least one heat pump that processes first humid air from the first processing compartment and second humid air from the second processing compartment.

In another aspect, a food cycler system can include a housing having a first volume; a first processing compartment for receiving a first bucket of first waste food, the first processing compartment configured within the housing; a controller for controlling, via the first processing compartment, a first food recycling process for the first waste food; a second processing compartment for receiving a second bucket of second waste food, the second processing compartment configured within the housing and wherein a second volume is associated with both the first bucket and the second bucket, wherein the controller controls, via the second processing compartment, a second food recycling process for the second waste food; and at least one heat pump configured within the housing and that processes first humid air from the first processing compartment and second humid air from the second processing compartment.

In some aspects, a method can include one or more of: receiving first food waste into a first removable bucket; receiving the first removable bucket into a first processing compartment; starting the first processing compartment to process the first food waste at a first time; receiving second food waste into a second removable bucket; receiving the second removable bucket into a second processing compartment; and starting the second processing compartment to process the second food waste at a second time, wherein the first processing compartment and the second processing compartment are configured to share at least one component for processing waste food in both the first processing compartment and the second processing compartment.

In another aspect, a system can include a first processing compartment configured to receive first food waste into a first removable bucket and configured to start processing the first food waste, via the first processing compartment, at a first time; a second processing compartment configured to receive second food waste into a second removable bucket and configured to start processing the second food waste, via the second processing compartment, at a second time; and at least one component that is shared for processing waste food in both the first processing compartment and the second processing compartment.

Systems can include one or more of a means for performing any step or operation disclosed herein. For example, a system can include one or more: means for receiving first food waste into a first removable bucket; means for receiving the first removable bucket into a first processing compartment; means for starting the first processing compartment to process the first food waste at a first time; means for receiving second food waste into a second removable bucket; means for receiving the second removable bucket into a second processing compartment; and means for starting the second processing compartment to process the second food waste at a second time, wherein the first processing compartment and the second processing compartment are configured to share at least one component for processing waste food in both the first processing compartment and the second processing compartment.

In some aspects, a computer-readable storage device can store instructions for controlling at least one processor, wherein the instructions cause the at least one processor to be configured to: receive first food waste into a first removable bucket; receive the first removable bucket into a first processing compartment; start the first processing compartment to process the first food waste at a first time; receive second food waste into a second removable bucket; receive the second removable bucket into a second processing compartment; and start the second processing compartment to process the second food waste at a second time, wherein the first processing compartment and the second processing compartment are configured to share at least one component for processing waste food in both the first processing compartment and the second processing compartment.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a hybrid food cycler system with two food cycler processing compartments according to an aspect of this disclosure;

FIG. 2 illustrates a top view of a representative food cycler or system according to an aspect of this disclosure;

FIG. 3A illustrates a rear view of a representative food cycler or system according to an aspect of this disclosure;

FIG. 3B illustrates a non-contact heat plate or heater according to an aspect of this disclosure;

FIG. 3C illustrates a side view of two food cycler processing compartments and the associated control system according to an aspect of this disclosure;

FIGS. 4A-4G illustrate various example food cycler systems and different views of various components, according to some aspects of this disclosure;

FIG. 4H illustrates a heat pump dehumidifier system, according to some aspects of this disclosure;

FIG. 4I illustrates a bucket design with internal cutting blades and teeth, according to some aspects of this disclosure;

FIG. 4J illustrates a button portion of a bucket with the different components including the bucket base and the bucket outer wall, according to some aspects of this disclosure;

FIG. 4K illustrates a cut-away of a bucket base with various o-rings and other structures to enable the grinding tool to be attached to the bucket, according to some aspects of this disclosure;

FIG. 4L illustrates a grinding mechanism or tool and some interior characteristics of an example bucket, according to some aspects of this disclosure;

FIG. 4M illustrates an example angle between a facing surface of a grinding mechanism to a blade edge, according to some aspects of this disclosure;

FIG. 4N illustrates an example grinding mechanism with an open space or cavity under one of the paddles, according to some aspects of this disclosure;

FIG. 5A illustrates a method embodiment of this disclosure, in accordance with some examples;

FIG. 5B illustrates another method embodiment of this disclosure, in accordance with some examples; and

FIG. 6 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Disclosed herein is a new system 100 that has a structure or configuration that is focused on maximizing the internal space that can be used for processing food waste, while reducing the external envelope volume as much as possible. The result is a high volumetric efficiency system (ratio of bucket capacity to product volume) for processing food waste. In particular, the system 100 enables the use of two or more buckets that can be inserted into respective food cycling compartments and independently operated while at the same time sharing potentially some components such as condenser systems, heat pumps, control boards, or dehumidification systems. Improvements disclosed herein include new bucket structures including in the grinding tool with an enlarged cavity under one of the blades to prevent clumping of food waste during processing and blades or teeth used to process food waste. A new volumetric efficiency of about 0.106 between the available bucket volume (across multiple buckets) and the overall volume of the system is disclosed. A modularized system as well as other improvements are disclosed as well such as food waste processing profiles, which can be selected based on feedback data or machine learning algorithm output.

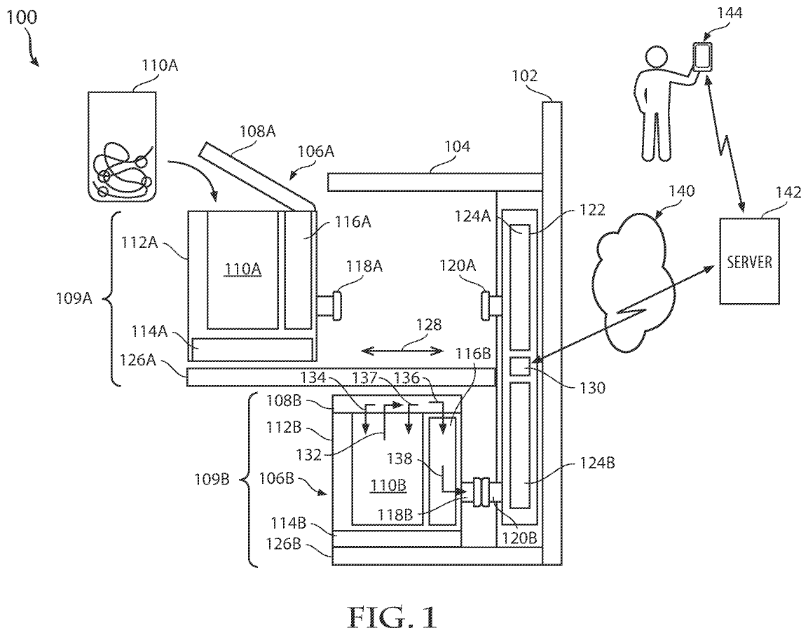

FIG. 1 illustrates an example system or set of food cyclers or system 100 according to an aspect of this disclosure. The system 100 includes two or more food cyclers or food cycler 106A, 106B. The food cyclers 106A/106B are configured as part of a respective first processing compartment 109A and second processing compartment 109B. The first processing compartment 109A and second processing compartment 109B can include any of one or more of the components shown in FIG. 1 and in general, the two processing compartments will share at least one component (e.g., a drain, a power supply, a filter, a controller, a master controller, a communication component, a heat pump, etc.). The system 100 can include more than two processing compartments 109A/109B as well and FIG. 1 illustrates one scenario where two compartments are shown. The general context of the application or benefit of the system 100 is a small business where a higher volume of food waste is produced such that the use of two buckets 110A, 110B (or more than two) may be sufficient to process the food waste. The buckets 110A/110B can have a volume of 10-15 liters or may have other sizes outside of this range. In one example size, the buckets 110A/110B can have a capacity of 12.5 liters each and can be 8-12 inches tall and have a diameter of 8-12 inches. The problem as suggested above is that in many real-world scenarios such as at a restaurant, food waste is continuously generated. Many larger food waste processors receive all at once a large amount of food waste for processing. But this batch mode of processing food does not match many scenarios where small amounts of food waste are continuously being generated. What is needed in the art is a food cycler system 100 that can enable non-batch processing but rather more continuous or independent processing by two or more food cyclers 106A/106B configured each as part of a respective processing compartment 109A/109B. The system 100 enables a first bucket 110A to be removable and perhaps out on a counter-top 104 to receive food waste. A second bucket 110B is also removable and can be on the counter-top 104 or in the second food cycler 106B in the second processing compartment 109B for processing. When the respective first or second bucket 110A/110B is inserted into the respective food cycler 106A/106B, a receiving cavity and the configuration of the respective first or second bucket 110A/110B can be complementary to enable the respective first or second bucket 110A/110B to lock into a drivetrain to enable a grinding mechanism in the respective first or second bucket 110A/110B to be driven by a motor 114A/114B for processing the waste food. The overall system 100 enables independent or asynchronous processing of food waste between the first food cycler 106A and the second food cycler 106B. A control system 130 may be in communication with each of the food cyclers 106A/106B for some aspects of managing the food processing cycles but also can enable the independent processing to occur.

Throughout this disclosure, some call-out numbers may only be shown as, for example, “202A”. The “A” reference means that the described features is shown with a first food cycler 106A or as part of the first processing compartment 109A but a corresponding and similar feature can also be used with one or more other food cyclers 106B or as part of the second processing compartment 109B in the overall system 100.

The respective food cyclers 106A/106B can each have a volume of approximately 12.5 liters in each bucket 110A/110B which volume can vary. The overall total volume of the system 100 can be approximately 236 liters or in terms of dimensions can be approximately 18 inches wide, 25 inches deep and 32 inches tall. These values can each vary +/−15%. In some aspects, the overall housing volume of the system 100 can be 150-250 liters and each bucket 110A/110B can have a respective volume of from 10-15 liters. The overall configuration is beneficial for a standard under-the-counter appliance. These are example measurements, and the size can vary 15% in either direction. In one example, the volumetric efficiency of the system 100 (ratio of bucket volume of multiple buckets to the overall system volume) can be 25 L/236 L=0.106. This ratio becomes possible given the disclosed configuration of components. Other ranges can also be used as well given minor differences in total bucket capacity for the system 100 relative to the overall volume of the system 100. For example, this disclosure can cover a dual food cycler system 100 with two food cyclers 106A/106B or two processing compartments 109A/109B with a volumetric efficiency of 0.070 to 0.140.

In one aspect, the system 100 includes two processing compartments 109A/109B that can each include one or more food cyclers 106A/106B with two buckets 110A/110B each with a respective volume and with an overall volume of the system having a volumetric efficiency of, for example, around 0.106 or a range of 0.070 to 0.140. When this disclosure indicates of a value of “at or around” or “about” a peculiar volumetric efficiency value means the value plus or minus 15% of that value.

The respective food cyclers 106A/106B can reduce food waste by grinding it into smaller particles and dehydrating the waste to remove water weight. The respective food cyclers 106A/106B or system 100 can include one or more processing chambers, each consisting of a grinding system (such as the motor 114A/114B, a drivetrain, power electronics, control electronics), a food waste vessel such as the first bucket 110A/110B which can also be described as a collection vessel or grinding bucket, air flow system (e.g., this can include heater(s) and can include a water condensation system, fan(s), vent(s), drain(s), actuator(s) for controlling air flow direction). The system 100 can be a stand-alone appliance, can be connected to multiple systems 100 through shared components/systems or can be installed under a counter 104 like a dishwasher. For example, the systems 100 can be connected through shared exhaust channels, odor systems, drain systems, heat pumps, control boards or control systems and/or any combination of these components.

Not shown in FIG. 1 is a power cord or mechanism to power the respective food cyclers 106A/106B. A wire could be used that would enable the movement 128 of the respective food cyclers 106A/106B to the stored and open configurations.

The system 100 can be configured to be operable under a counter-top 104. A wall 102 is shown as well to give some context to one example configuration. The first food cycler 106A can be configured on an extendable shelf with a first drawer slide 126A that enables a user to pull the first food cycler 106A out such that the first food cycler 106A is accessible. In one example, the first food cycler 106A includes a lid 108A, a housing 112A, internal components 116A which can include a filter, a fan, a heater to heat air and so forth, and a motor 114A which can include a heat component to heat the first bucket 110A. The second food cycler 106B can include a second motor 114B and heat component. The first bucket 110A and the second bucket 110B can be in a configuration as is shown in U.S. patent application Ser. No. 17/404,017, filed on Aug. 17, 2021, the contents of which are incorporated herein by reference.

Features such as a first drawer slide 126A and a second drawer slide 126B can also be characterized as respective sliding brackets that enable the movement of the respective food cyclers 106A/106B in a manner similar to opening a sliding drawer. Thus, the first drawer slide 126A and the second drawer slide 126B can be used to enable the respective food cycler 106A/106B to be pulled out like a drawer.

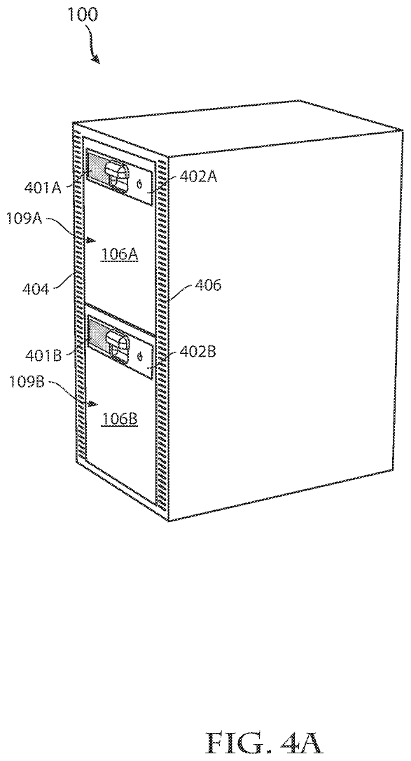

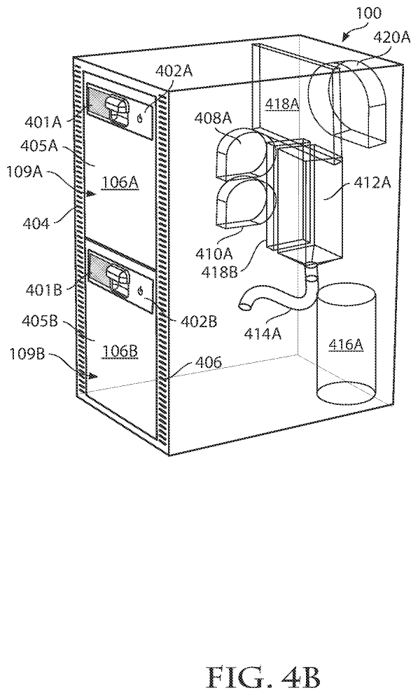

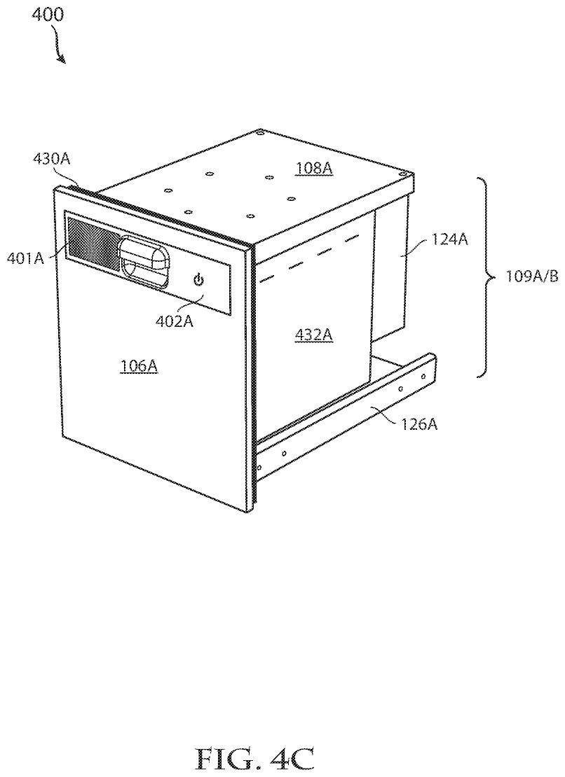

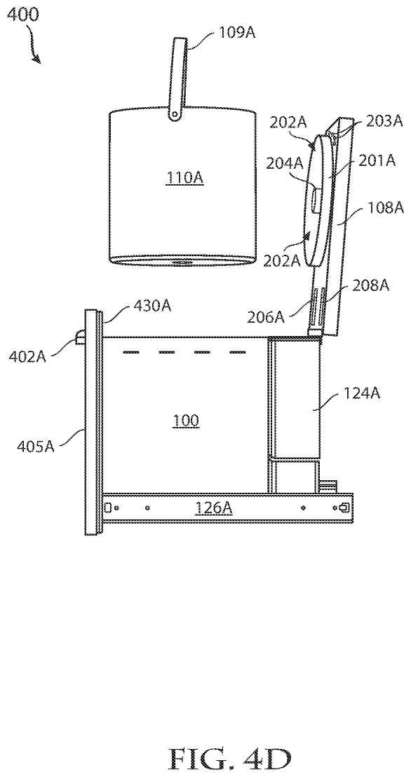

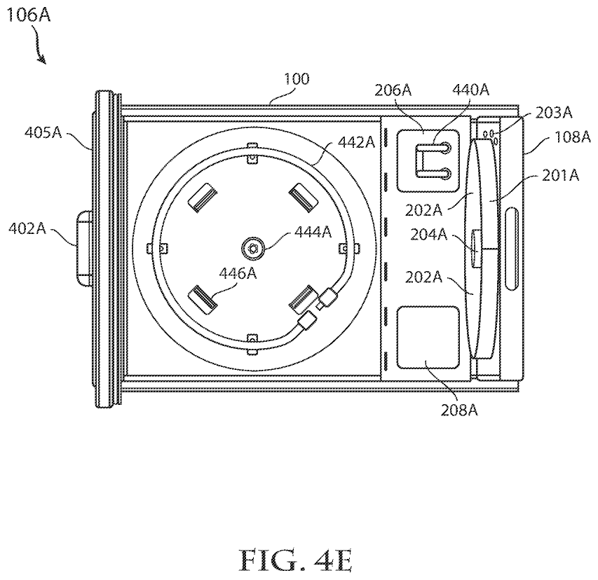

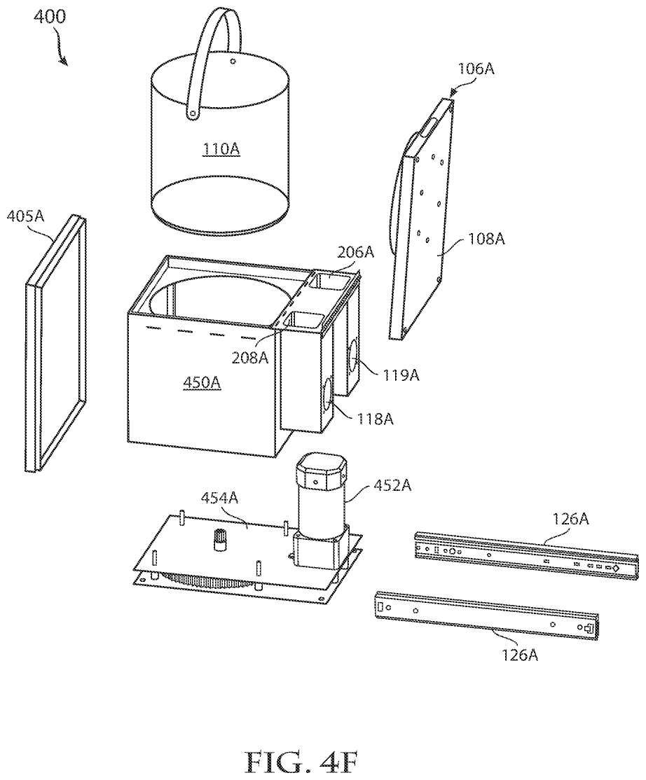

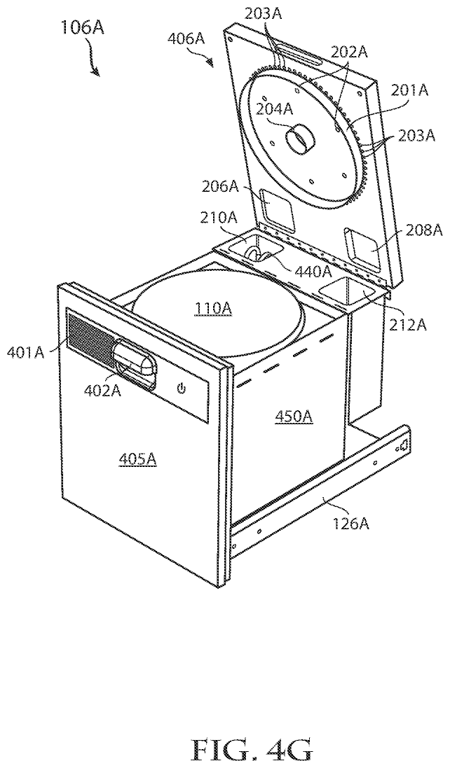

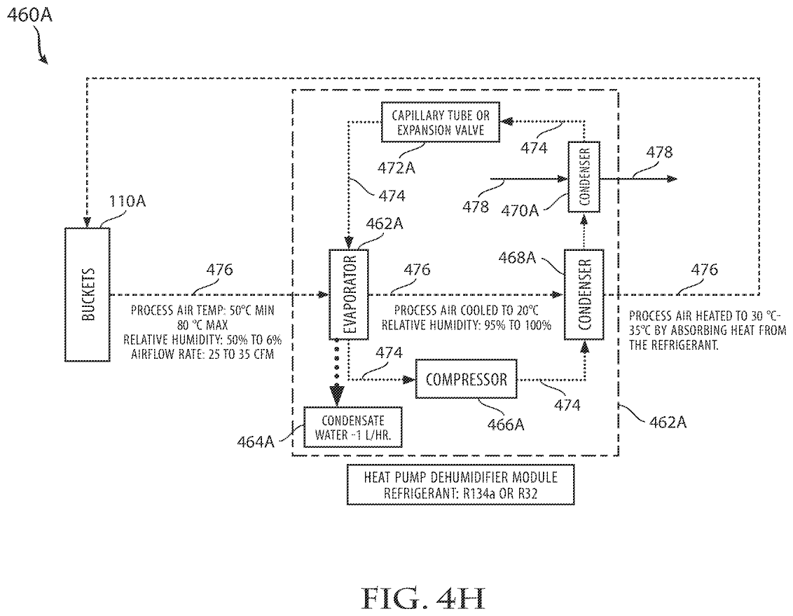

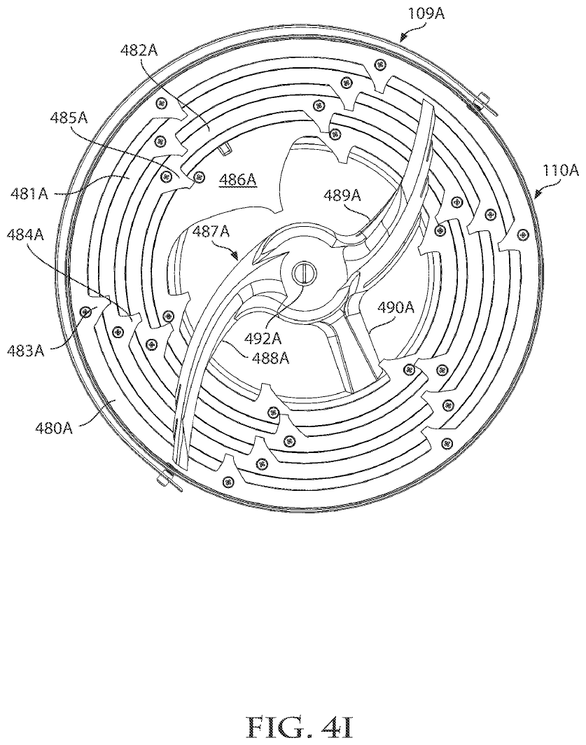

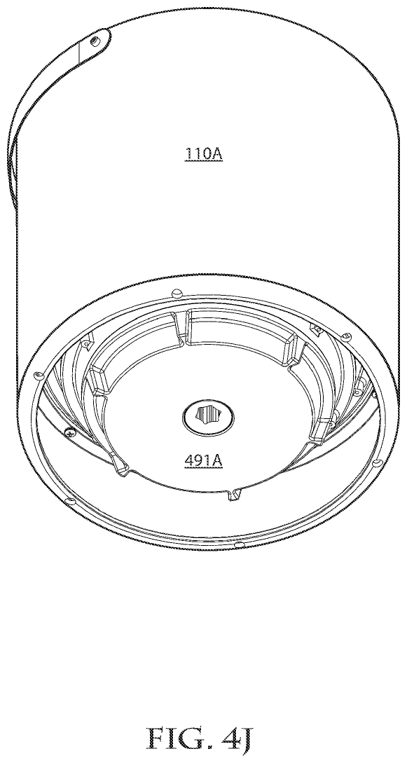

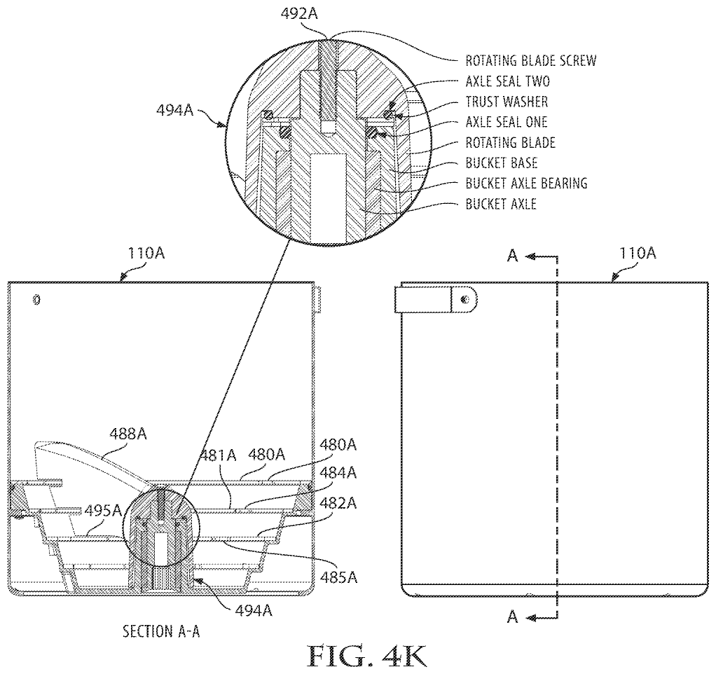

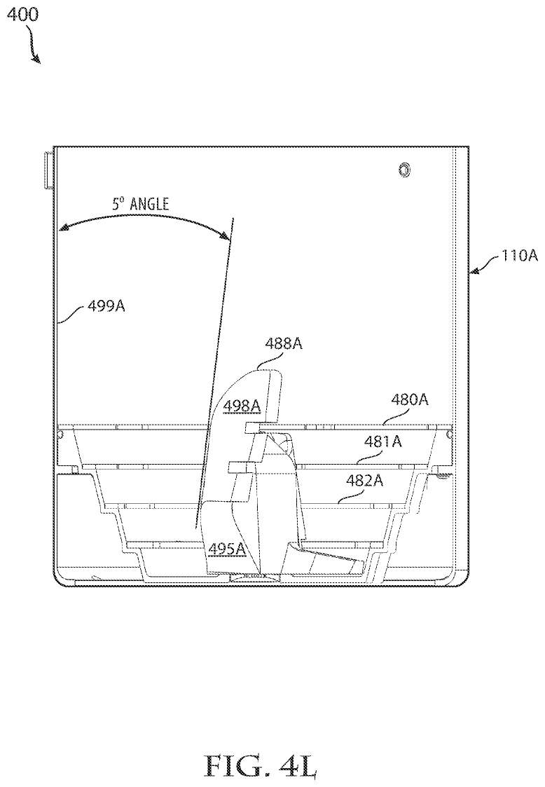

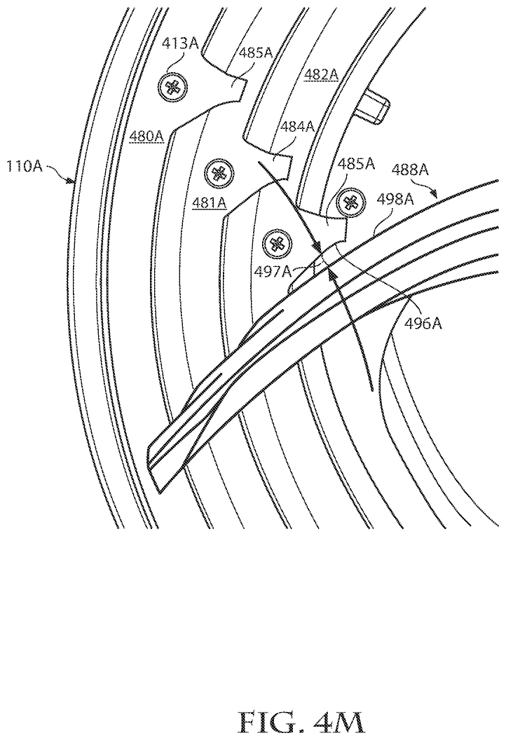

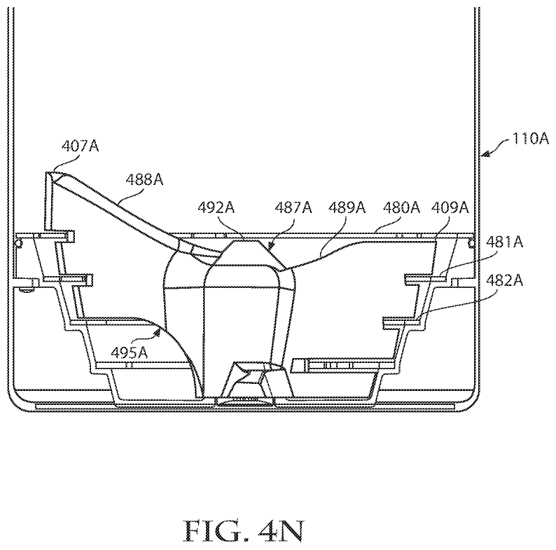

The first processing compartment 106A can include a first exhaust port 118A that when the first food cycler 106A is moved via the movement 128 back into a stored position can connect with a complementary first exhaust port 120A. The first exhaust port 120A can connect with a heat pump 122 that can include one or more of a compressor, an evaporator, and one or more condensers. The heat pump 122 can include various components such as are disclosed in FIG. 4H that contains an evaporator, a compressor and one or more condenser systems. The heat pump 122 can include a heat exchange as well. Thus, the heat pump 122 is meant to be any type of condenser system that condenses liquid from the humid air exhaust from the one or more buckets 110A. The second food cycler 106B is shown in a stored configuration with its second exhaust port 118B connected to or touching the complementary second exhaust port 120B. Air flows through the internal components 116B and the lid 108B as shown with example arrows 132 (exhaust flow), heated airflow 134 (input flow), heated airflow 136 (output flow to filter), 137 (input flow), output airflow 138 (output flow to heat pump 122). Not shown here is a flow in the reverse direction of a flow of the output airflow 138 with air being provided to the internal component 116B for preheating and insertion into the bucket 110A.

In some aspects, at least one condenser configured with the heat pump 122 can be exposed to ambient air to add or remove heat from the system 100.

Note that a heated airflow 134, 136 represented by arrows can include a pathway of air flowing down an interior wall of the first respective bucket 110A. One challenge with these systems is pushing pre-heated air to the food waste to draw out the moisture from the food waste. Hot air tends to rise, however, and thus must be pushed down. By introducing the heated airflow 134, 136 at the sides of the first bucket 110A, the air can follow the side wall using the Coanda effect known in thermodynamics. The jet of air in this case tends to attach itself and flow along the surface of the bucket and thus more of the heated air is likely to interact with the food waste. Further, reversing the airflow can add a benefit of cooling down the bucket/system which is a useful result at the end of the cycle.

The exhaust ports may also be configured as flexible members or members with a telescoping configuration that maintains a channel as the food cyclers 106A/106B are moved back and forth via the movement 128. In the stored position, humid air from the buckets 110A/110B can flow through the internal components 116A/116B (such as a fan, air filter, and so forth) through the exhaust ports 118A/118B and 120A/120B to the heat pump 122. The heat pump 122 in one aspect can include a heat pump with a refrigerant to draw out the moisture from the air exhausted from the respective first or second bucket 110A/110B. Gaskets can be used with the exhaust ports 118A/118B and 120A/120B to ensure a good seal in the stored position for the respective first or second feed cycler 106A/106B. The gaskets can protect against odors as well leaking into the room where the system 100 is configured.

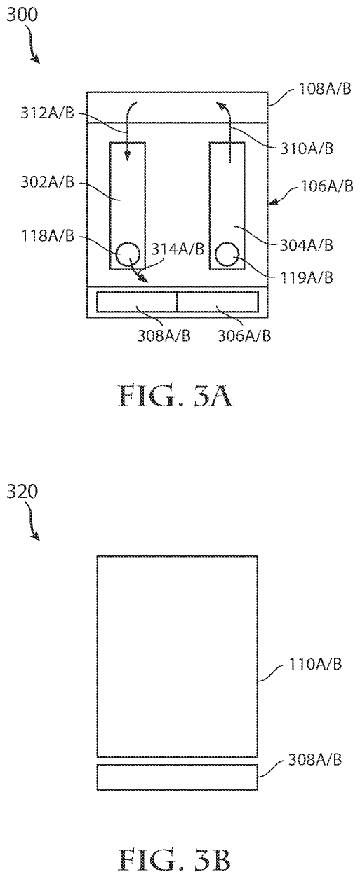

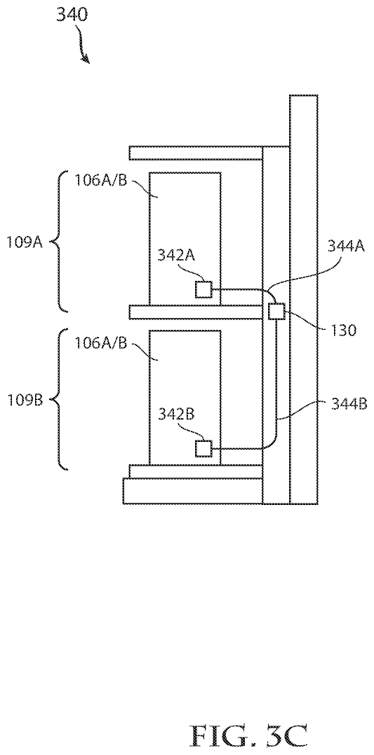

The exhaust ports 118A/118B and the input ports 119A/119B shown in FIG. 3A can include dampers or other actuators in communication with the control system 130 such that airflow can be managed to and from the respective first or second food cyclers 106A/106B.

One aspect of the airflow control can relate to dust that is generated from the processing of food waste. Depending on the processing cycle and the type of food waste being processed, the dehydration process can generate dust that can be problematic as it can get into the exhaust port 204A and jam or clog air passageways. The lid 108A design including the airflow in and out of ports 202A/203A/204A can be selected or managed to reduce the amount of dust generated in a food processing cycle based on various factors. In one aspect, as part of a food processing cycle, the direction of airflow can be reversed for a period of time to reduce the production of dust and to cool down the buckets or any portion of the system 100.

For example, a first cycle to process the first waste food via the first processing compartment 109A that starts at a first time can include one or more of: using contact heating with the first removable bucket, using non-contact heating with the first removable bucket, causing air to flow in a first direction during a first portion of the first cycle and causing air to flow in a reverse direction in a second portion of the first cycle. A second cycle to process the second waste food via the second processing compartment 109B that starts at a second time comprises one or more of: using contact heating with the second removable bucket, using non-contact heating with the second removable bucket, causing air to flow in the first direction during a first portion of the second cycle, and causing air to flow in the reverse direction in a second portion of the first cycle. The reverse airflow can reduce the production of dust, cool down one or more components of the system, or have other impacts on the system 100.

The heat pump 122 can include a heat pump system to condense the exhausted humid air by using vapor compression refrigeration principle. In some aspects, at least one condenser configured with the heat pump 122 can be exposed to ambient air to add or remove heat from the system 100.

The movement 128 of the first food cycler 106A enables it to be pulled in a horizontal direction to enable ingress and egress of the first bucket 110A. The second food cycler 106B similarly can be configured to be pulled in the horizontal direction to enable ingress and egress of the second bucket 110B.

The heat pump 122 can also include separate individual condenser systems for each food cycler 106A/106B. Shown in FIG. 1 is a first condenser system 124A that can condense liquid from the humid exhaust air from the first food cycler 106A and a second condenser system 124B that can condense liquid from the humid exhaust air from the second food cycler 106B. The heat pump 122 may also include a single condenser system that covers two or more of the food cycler compartments 106A/106B. For clarification, the condenser “systems” described herein can include by way of example a heat pump as shown in FIG. 4H that includes an evaporator and one or more condenser systems as well. Another name for the heat pump 122 can be a dehumidifier system in that it may or may not include an evaporator/condenser pair as shown in FIG. 4H.

The use of two food cycler compartments 106A/106B is only exemplary and more than two could be configured in the same system and could share one or more heat pump 122. The heat pump 122 may or may not be used or needed. In one aspect, the system could be a “closed loop” system with the heat pump 122 removing moisture from the humid air from the food cyclers 106A/106Bs and returning the air back to the food cyclers 106A/106B for additional food waste processing. In another aspect, the system 100 may be attached to a channel that leads outside a building defined by the wall 102 where no heat pump 122 is needed. In this sense, the system 100 can be an open loop system with humid air from the food cyclers 106A/106B ported directly outside a building.

The ability to remove water from the system 100 in various ways can be modular in a sense. Different buildings have different configurations. The system 100 can be assembled in different configurations permitting different installation scenarios. For example, as a closed air loop, a water condensing system can drain the condensate water out to some existing building infrastructure. As an open-air system, the system 100 can vent all the water vapor from the food waste to the outdoors. As an open-air system, the system 100 can vent all the water vapor from the food waste to a building ventilation/extraction system. Further, as an open-air system, the system can vent all the water vapor from the food waste to a building plumbing vent system. The system 100 can be modular in a sense that the different moisture processing approach can be chosen based on the building characteristics and switching between these types of systems can involve changing out a heat pump 122 as a unit. Thus, feature 122 may represent a modular component that might include vents to an interior plumbing system or to a vent to outside the building or may include one or more condenser systems for a closed-loop system as disclosed herein.

For example, a waterless P-trap (check-valve or drain) can be provided for venting air from the system 100 to other air management systems of a building or a plumbing stack of the building. The system 100 may incorporate an electronic input/output to interface with infrastructure air handling equipment. In one example, such a component may only run if/when it is safe to do so.

A first extension member or first drawer slide 126A represents the structure that can be used to pull the first food cycler 106A from a stored position to an accessible position in which the first bucket 110A can be removed or inserted into the first food cycler 106A. A second extension member or second drawer slide 126B can similarly enable the second food cycler 106B to be moved from a stored configuration to an accessible configuration. These can independently operate. The control system 130 or controller may provide via a wireless communication or a wired communication a status of the food cyclers 106A/106B. For example, the different food cyclers 106A/106B or processing compartments 109A/109B can communicate with a control system 130 that may be shared via a wired communication channel or a wireless link or wireless communication protocol such as WiFi, cellular, 5G, and/or BlueTooth. Other protocols are contemplated as well. In some aspects, control system 130 can represent a combination of a master controller that communicates with respective local controllers each configured with a respective processing compartment 109A/109B. In some aspects, control system 130 can represent of a master controller that communicates to each processing compartment 109A/109B directly. Other components can be included such as a lock which can be configured to lock in the respective food cycler 106A/106B that is processing waste food and should not be opened. The control system 130 can include functionality to manage the multiple food cycling processes and provide notices for example to users when a respective food cycling process is complete and when the respective bucket 110A/110B can be emptied. For example, the control system 130 can manage and monitor the respective independent cycles of the food cyclers 106A/106B and transmit a notice to a remote server 142 through the internet or other network 140. The server 142 may transmit a message to a mobile device 144 of a user that informs them of the status of one or both of the food cyclers 106A/106B. A user profile or application may be configured to receive notices as desired such as when both food cyclers 106A/106B have completed their food waste processes or when each one has completed the food waste process.

The system 100 disclosed can be modular as well. For example, there can be multiple drawers in the system 100 beyond two. The food cyclers 106A/106B are designed in one aspect to include serviceable modules. The modules facilitate assembly, but also servicing, by breaking the product down into more easily serviceable/replaceable modules. For example, the motor 114A/114B can represent a drive-train module in general, internal component 116A/116B can represent a heating or filter module. The heat pump 122 can also be a replaceable module as noted above. In this regard, for example, the system 100 can be configured such that when the first food cycler 106A is in an extended position as shown in FIG. 1, then not only is the first bucket 110A able to be retrieved or inserted into the first food cycler 106A, but the configuration could also be configured to enable modular replacement, for example from a side position, of other components. The motor 114A/114B could be an entire drive train module that could be slide out and replaced with a new drive train module or motor 114A/114B. One or more of fans, heaters, air vents, could be included in the as part of the internal component 116A/116B which could also be removed and replaced with a new component from a side position. Further, the first food cycler 106A may also be lifted off of the first track or first drawer slide 126A to enable access into the interior and further enable access to the first condenser system 124A which could also be replaced as a modular component.

The system with respect to whether it is a closed-loop system or an open-loop system can be modular as well. For some buildings where an open-loop system 100 is possible, the modular components can be used which vent humid air from the first bucket 110A to a building system or to the outside. Where no such venting is possible, the system 100 can be installed with the modular components which recirculate the air, including the heat pump 122, and return heated air into the first bucket 110A in a closed-loop fashion. The modular capability may easily enable a system 100 to be installed in one building in a closed-loop configuration with a heat pump 122 and then be moved to another building and easily transitioned to an open-loop system by replacing the heat pump 122 with a venting structure that fits or is complementary to the plumbing or other venting available for that building.

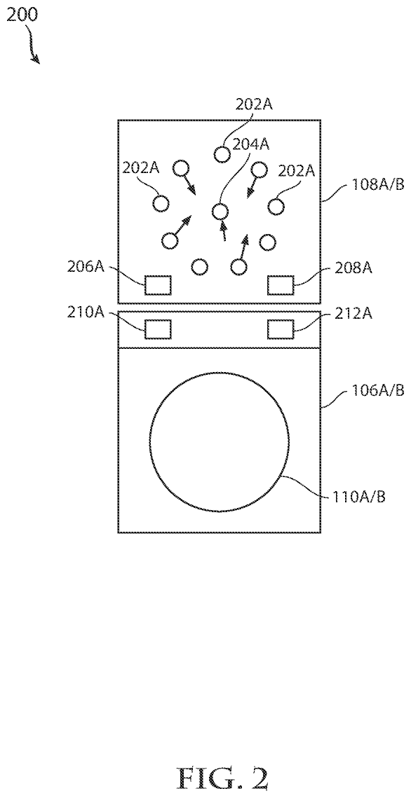

FIG. 2 illustrates from a top view the food cyclers 106A/106B with an open lid 108A/108B. The bucket 110A/110B is shown as well as example ports 210A/212A which can represent ports for air to flow in either direction in or out. Complementary ports 206A/208A are shown in the lid 108A/108B and ingress and egress openings 202A, 204A are shown. An example of the airflow is as follows. Pre-heated air can be provided from port 210A to the lid via port 206A. When the lid 108A/108B is closed, the two ports 210A/206A are connected such that air can flow. The internal components 116A/116B can include such features as a fan, a heater and so forth. Air can be preheated (or not) and provided through the ports 210A/206A to the lid 108A/108B. Ports 202A are example ports that can provide air into the bucket 110A/110B for processing the food waste and to extract moisture from the food waste. The humid air from processing the food waste can be withdrawn from the bucket 108A/108B via a port 204A in the lid 108A/108B. The number of ports and the positioning of the ports in the lid 108A/108B are provided by way of example only. The numbers and positioning can vary at different locations within the lid 108A/108B.

The positions of ports 202A to provide air into the respective first or second bucket 110A/110B and the exit port 204A generally are chosen to prevent heated input air entering the respective first or second bucket 110A/110B to simply interfere with the exhaust air which should flow into the exit port 204A having liquid therein drawn from the food waste. Thus, in one example, the input ports 202A are configured around a perimeter of the respective first or second bucket 110A/110B and the exit port 204A is positioned in a central area of the lid 108A/108B. This positioning also takes advantage of the Coanda effect as mentioned above. These could be reversed as well or could be provided in other configurations depending on a desired air flow pattern. In one example, the system might determine a characteristic of food waste and then select which are input ports and which are exhaust ports in the lid 108A/108B. The amount of food waste in the respective first or second bucket 110A/110B may also cause the control system 130 to adjust regarding how to manage airflow of heated air into the respective first or second bucket 110A/110B to draw out liquid from the waste food. A shape or location of various waste food might also be a characteristic that is used to decide the air flow. In one example, it might provide better liquid transfer from the food waste to the air if the pre-heated air is input from the central port 204A and having ports 202A as exhaust ports. The air flow can even be controlled in a more fine-tuned manner with ports configured across the lid 108A/108B and controllable structures or actuators within the lid 108A/108B being adjustable to cause air to flow to one or more port for input and one or more port for egress of air from the respective first or second bucket 110A/110B. For example, valves or airflow control damper actuators can be configured within the lid 108A and/or in other locations such that airflow in or out of the lid 108A is controlled and the particular ports 202A, 204A can be selected. In this manner, the system 100 may based on parameters such as food waste characteristics or other values, select a certain air flow to optimize the dehydration of the food waste.

FIG. 3A illustrates a rear view 300 of the food cyclers 106A/106B. Shown is the lid 108A/108B and example filters 302A/302B, fans/heating components 304A/304B, example motors 306A/306B and example heating components 308A/308B. An input ports 119A/119B are illustrated which can receive air from a heat pump 122 (when one is used) or from another source for pre-heating and insertion into the respective first or second bucket 110A/110B. The exhaust ports 118A/118B is also shown. The airflow can include a first path 310A/310B to the lid 108A/108B from which the air will flow into the bucket 110A/110B to extract moisture from the food waste and return to the lid 108A/108B and then exit the lid through a path 312A/312B through the filter 302A/302B and out the exhaust ports 118A/118B via path 314A/314B. This provides an example of one of many possible air flow pathways through the food cyclers 106A/106B. In one aspect, the airflow paths or configuration of the food cyclers 106A/106B may differ between the different food cyclers 106A/106B. Each on may have an independent or different configuration for the internal components including the air flow path.

Volumetric efficiency of the system 100 can be also adjusted based on the use of the heat pump 122 and what the structure of the heat pump 122 is such as whether a single heat pump 122 is used or independent separate first condenser system 124A or second condenser system 124B are used, or whether the system does not use condensers because the infrastructure of a building can accommodate venting to a plumbing or other system or to the outside.

FIG. 3B illustrates a non-contact heat plate or heater 308A/308B that provides heating to the first or second buckets 110A/110B without directly contacting the respective bucket. There are several innovations related to the heater. In one example, the respective food cyclers 106A/106B can have one or more methods for heating the food waste. Existing systems primarily rely on heat transfer through conduction between a heat-plate and a bottom of the bucket 110A/110B, which can be an inconsistent method as it is dependent on having good surface contact through manufacturing methods. The system 100 can employ either contact heating, non-contact heating, or both. The disclosure is not limited to any specific type of heating between the heat-plate and the bottom of the bucket 110A/110B.

Thermal pads or grease is not a viable option as they would wear quickly or become messy with frequent bucket insertion or removals. Therefore, one aspect of this disclosure is a non-contact heating approach that can include one or more of infrared radiation emitters (lamps, ceramics); microwaves; induction heating; air heaters; central heating (unit injects air through the center hole and flows out of the surrounding holes); peripheral (unit injects the air through the peripheral holes and exhausted through the center hole); a blade method (unit supplies the air through holes in the rotating blade in the bucket); and Peltier devices (thermoelectric cooling devices that use the Peltier effect to create a heat flux at a junction of two different types of materials). A Peltier cooler, heater, or thermoelectric heat pump is a solid-state active heat pump which transfers heat from one side of the device to the other, with consumption of electrical energy, depending on the direction of the current. Such an instrument is also called a Peltier device (that provides both heat and cooling to condense water), Peltier heat pump, solid state refrigerator, or thermoelectric cooler (TEC) and occasionally a thermoelectric battery. It can also be used as a temperature controller that either heats or cools. In one aspect, heat recovery systems may also be used to generate energy or to capture excess heat for other purposes such as pre-heating air that is to flow back into the respective first or second bucket 110A/110B. For example, wasted heat energy from the heat pump 122 can be recycled and used to heat the intake air used for dehydrating the food waste. This is particularly useful in the closed-loop version of the system 100.

The non-contact heater 308A/308B in one example, can provide some heat to the respective first or second bucket 110A/110B while a preheating component can be part of component 304A/304B to pre-heat air 310A/310B that flows into the respective first or second bucket 110A/110B. Thus, the heating of the waste food in this regard can come from a combination of two heat sources. The control system 130 can utilize data and also manage what level of heat comes from a first heat source and what other level of heat comes from a second heat source. These decisions may be based on a characteristic of the waste food in one example. If the waste food has a lot of liquid, it may be more efficient to use 80% heat from a non-contact heat place or other heat sources from component 308A/308B and 20% heat from pre-heating air 310A/310B. However, if the food waste is bone or other material that has different characteristics or is even positioned differently in the respective first or second bucket 110A/110B (say up higher in the respective first or second bucket 110A/110B), then a higher percentage of the overall applied heat can come from the heating element that pre-heats the air 310A/310B. Thus, the dehydration of the food waste can be achieved by two or more sources of heat to the food waste. Thus, the location where heat is applied can also vary.

Furthermore, the amount of heat can be applied in a variable way throughout a processing cycle. The percentages of the total heat coming from different sources can also vary across the waste food processing cycle. There are alternate approaches to managing air flow and how much heat is in the incoming airflow 310A/310B.

In another aspect, with airflow there are air currents that are developed which can exist or be configured based on the structure of the lid 108A/108B and/or the respective first or second bucket 110A/110B. The characteristic or configuration of the food waste can also cause certain air currents to be generated. Thus, these are the kinds of factors that can cause the control system 130 to adjust the air flow into and out of the respective first or second bucket 110A/110B.

FIG. 3C illustrates a side view 340 of the food cyclers 106A/106B with a focus on control systems. The control system 130 is shown as being connected via wired or wireless connections 344A/344B respectively to a first control system 342A for the first food cycler 106A and a second control system 342B for the second food cycler 106B. The communication channels or connections 344A/344B may be wired or wireless using any known or future-developed communication protocol such as WiFi or BlueTooth. The function operation of the respective food cyclers 106A/106B can be divided between the control system 130 and the respective control systems 342A/342B. For example, the control system 130 may receive communications from a server 142 to provide updates to the respective control systems 342A/342B or to transmit data received from the respective control systems 342A/342B. As noted above, the individual food cyclers 106A/106B may operate independently on cycles run by the respective control systems 342A/342B. The first food cycler 106A may receive the first bucket 110A and start a food waste cycle at say 10 AM. During the cycle, the second bucket 110B may be positioned on a counter-top to receive food waste. When the second bucket 110B is full, a user can insert the second bucket 110B into the second food cycler 106B and start its food waste cycle at say 10:30 AM. The different food waste cycles will run independent of each other. However, each respective food cycler 106A/106B may report data to the control system 130 for aggregation of data and overall management. As mentioned before the system 100 can also be employed where control system 130 is connected via wired or wireless connections 344A/344B directly to each compartment without the need of respective control systems 342A/342B.

In one aspect there are a number of features available in this system that help customers process waste food. The system 100 can enable data collection and reporting to the server 142 or back to the user device 144. The system 100 can process data such as weight, cycle time, power consumption, other parameters throughout a cycle, and other factors would be collected and used as a testing data source to further improve future food waste processing algorithms.

In one example, an IoT “Internet-of-Things” functionality can allow the user to control their unit using a smartphone application on a mobile device 144, to change operating settings, to monitor the current device parameters, to estimate the current state of the processing cycle, and to view overall performance statistics.

Other control system examples can include a delay start so that the system 100 starts at off-peak hours. If the user pays for electricity based on a variable “time-of-usage” rate, the unit can be programmed to delay start until the lowest rate time of day. The system 100 can provide a completed cycle summary (weight reduced, time it took, power consumption).

FIG. 4A illustrates an exterior view of the system 100 with the first food cycler 106A with a handle and/or display 402A and the second food cycler 106B with a handle and/or display 402B configured thereon. The respective handles and/or displays 402A/402B can be used to pull out each respective food cycler 106A/106B to access the respective first or second bucket 110A/110B. A first condenser air intake 404 is shown as well as a second condenser air intake 406. These can be used for a single heat pump 122 or for individual air condenser systems 124A/124B. A vent 401A/401B including in one aspect a filter is shown for each respective food cycler 106A/106B.

FIG. 4B illustrates additional features of the system 100. A first drawer front 405A can be used for the first food cycler 106A and a second drawer front 405B can be used for the second food cycler 106B. Internal components shown can include air blower fans 408A/408B for moving air within the system 100, a condenser blower fan 420A, a compressor 416A, an evaporator 412A and a condensate drain 414A. A first condenser system 418A can correspond to the first condenser system 124A shown in FIG. 1 and a second condenser system 418B can correspond to the second condenser system 124B in FIG. 1. The “A” of the callout numbers in FIG. 4B can represent that each component might relate to a single first food cycler 106A and that there may be a corresponding “B” component separately operable with the second food cycler 106B. In some scenarios, some components such as the evaporator 412A and the compressor 416A would service two or more condenser systems 418A/418B. Note that the condenser systems described here can different types which may or may not include evaporators and condensers as shown in FIG. 4H.

FIG. 4C illustrates some features 400 of an example first food cycler 106A. A drawer gasket 430 can be used to secure or prevent odors from entering a room. An example first drawer lid 108A is shown. A bucket compartment 432 can be configured to have a receiving cavity for the first bucket 110A. The first condenser system 124A can house the various components discussed herein. The first drawer slide 126A is shown by way of example as well. A vent 401A is shown as part of the handle and/or display 402A or other feature which vent can be used to enable odor or other air to be vented out of the system 100 when a drawer is closed. The vent 401A can include a filter as well which can filter air or odor which may leak from any of the air ducts disclosed within the system 100. This can be a form of odor control as well. The air gaps around the bucket compartment 432A can be sealed off via the drawer gasket or the first gasket 430A which can protect against odor leaking into a room or kitchen. Each respective food cycler 106A/106B can have a respective gasket such as the first gasket 430A and/or the second gasket 430B. The extra level of odor protection can include an air filter in the vent 410A or some other secondary filtering system to protect from such odor which may leak from other air ducting of the system 100. Thus, an aspect of this disclosure is a first filter system for filtering air within defined ducts or channels and a second filter system for filter odors from air leaked from the defined ducts or channels into an airspace around the one or more food cyclers 106A/106B.

Odor control can include such features as sealing components, ozone generation, converting air, filtering components, and masking features. The system 100 can limit odors by processing air in a closed-loop system. Odors can be limited by adding ozone to the process air to oxidize food odor particles. Further, odor can be controlled by adding components to the process air that masks odors. Furthermore, the system 100 can incorporate a sealed outer shell to capture any leaked process air. This smaller volume of leaked air can also be filtered as noted above by a second filtering system at a location such as the vent 401A. The drawer gasket of the first gasket 430A also helps to seal off a room from receiving leaked odors.

FIG. 4D illustrates features 400 of the system 100 with the first bucket 110A above the first food cycler 106A. The first bucket 110A can include a first handle 109A. The first lid 108A is shown with the intake port 206A and an exhaust port 208A. The input ports 202A in the first lid 108A are shown as being on the interior of a circular member 201A configured on the first lid 108A. The circular member 201A can be used to assist in air flow direction and to prevent air flowing into the first bucket 110A from interfering with air flowing out of the first bucket 110A to the output port 204A. The desire to prevent contamination of the flow of air can be useful because the input air is dry and its purpose is to draw moisture out of the food waste being processed. Accordingly, the disclosed structure can assist in keeping the input air flow and the output airflow from the first bucket 110A. FIG. 4D also includes an example of where input air ports 203A are configured on an exterior portion of a circular member 201A. This configuration can take further advantage of separating the input air flow from the input ports 203A and the exhaust port 204A. A first gasket 430A is shown as configured on the interior edge of the first drawer front 405A.

The structure of the lid 108A and the circular member 201A in connection with the input air ports 203A can take advantage of the Coanda effect for air flow. Fluids flowing near a surface (such as the interior surface of the first bucket 110A) tend to follow the shape of the surface. This is true for airplanes and sailboats. The system 100 through the structure of the lid 108A can direct dry air downward and parallel to the bucket inside wall surfaces. The Coanda effect would cause the air to penetrate deep into the bucket maximizing its interaction with wet food waste and thus allow the air to strip more moisture from the food waste. One benefit is for the hot air, which does not have a tendency to want to move downward, can be forced out through the input ports 202A, 203A and by taking advantage of the Coanda effect can enable the hot air to flow down into the food waste. Note that the particular location of the input ports 203A in FIG. 4D can correspond to the location of the input ports 202A shown in FIG. 2.

FIG. 4E illustrates a top view of the first food cycler 106A which shows a drivetrain axle 444A, a non-contact heating element 442A, an air heating element 440A, the input port 206A and the exit port 208A. The lid 108A is shown with the input ports 202A, the input ports 203A, and the exit port 204A. The circular member 201A is shown as well. FIG. 4D also illustrates the input portson an exterior of the circular member 201A. The input ports 203A are shown as well around the circular member 201A.

FIG. 4F illustrates an exploded view of the first food cycler 106A. The various components are shown including the first drawer front 405A, the first bucket 110A, the first bucket compartment 450A, the exhaust port 118A and input port 119A, the first electric motor 452A and a first drivetrain 454A. The first drawer slide 126A is shown as well as the drawer lid 108A.

FIG. 4G illustrates the first food cycler 106A with the various components such as the bucket intake or heat pump exhaust ports 203A configured on an exterior portion of circular member 201A of the lid 108A. Other example exhaust ports 202A are shown in an interior portion of the circular member 201A of the lid 108A. The bucket exhaust or heat pump intake 204A is shown in the middle portion of the circular member 201A. The other components such as a heater or the air heating element 440A which can be used to preheat bucket intake air are shown. The vent 401A is shown as well as the input ports 203A on an exterior of the circular member 201A.

FIG. 4H illustrates an example heat pump 122 as a heat pump dehumidifier system 460A. The first bucket 110A provides processed humid air such as the bucket intake air 476 or exhaust air to an evaporator 463A that is part of a heat pump dehumidifier module or the single evaporator 462A. The evaporator 463A produces a water condensate 464A in that it creates a cold surface to condense water. A refrigerant 474 is shown as part of the heat pump dehumidifier module or single evaporator 462A as transitioning from the evaporator 463A to a compressor 466A to a first condenser 468A that receives processed air cooled at 20 degrees C. with a relative humidity and produces air heated to, for example, 30-35 degrees C. by absorbing heat from the refrigerant 474. The first condenser 468A can be used by way of example to preheat bucket intake air 476. The refrigerant 474 is further processed by another condenser such as a second condenser 470A that processes room temperature air flow 478. The second condenser 470A can be used to release excess heat into a room containing the system 100. A capillary tube or expansion valve 472A further processes the refrigerant 474 and returns the refrigerant 474 to the evaporator 463A. The temperature values shown in FIG. 4H are illustrative only and other values +/−30 percent of these values are contemplated.

The heat pump dehumidifier system 460A may in a module form only include the first condenser 468A where the system 100 might be able to vent excess heat outside of a building. Thus, the second condenser 470A may not be needed. Different food cyclers 106A/106B may have their own individual components of a heat pump 122 such as separate heat pumps in the heat pump dehumidifier system 460A or the system may include for example a single evaporator 462A for two food cyclers 106A/106B and share other components such as condenser systems 468A/470A, compressors 466A or expansion value 472A. The sharing of one or more components of a heat pump 122 may enable improved volumetric efficiency involving multiple food cyclers 106A/106B.

FIG. 4I illustrate the first bucket 110A with a grinding mechanism or grinding tool 487A having a first paddle 488A, a second paddle 489A and a third paddle 490A. Fixed blades 480A, 481A, 482A are exemplary and more blades are shown. Each of the blades is screwed into a protruding shelf of the interior surface of the first bucket 110A. Individual fixed teeth 483A, 484A, 485A are shown by way of example in connection with each set of blades 480A, 481A, 482A with a new design to shed fiber during food processing. Note that there is a perpendicular edge and a sloped edge with a square top portion of each tooth. A lower tooth 486 is also shown which can be near the third paddle 490A. A rotating blade screw 492A is used to screw in the grinding mechanism or grinding tool 487A to the bucket axil shown in FIG. 4K. The shape of the two main paddles 488A and 489A has a reduced vertical sweep angle relative to the configuration from the application incorporated herein by reference above to reduce the tendency of large round food waste such as potatoes or apples from avoiding the fixed blades and not being cut. The rotating blade screw 492A is shown to attach the grinding tool 487A to the first bucket 110A.

FIG. 4J illustrates a lower portion of the first bucket 110A in which the bucket outer wall can be deep drawn or formed from sheet metal. A bucket base 491A can be die cast for example. The bucket can therefore be configured from two different pieces of different types of material and assembled to make a final bucket 110A. The screws used to attach the different fixed blades 480A, 481A, 482A can be screwed down into a ledge or a portion of the bucket base 491A and/or through holes upper portion of the bucket.

FIG. 4K illustrates a sectional view across Section A-A of the first bucket 110A. The view shows one of the paddles 488A of the grinding tool 487A. A first bucket base 494A is shown in cut-out with the finer details shown for the rotating blade screw 492A and other components such as an axle seal one, an axle seal two, a trust washer, a rotating blade (i.e., the paddles 488A, 489A), a bucket base, a bucket axle bearing and a bucket axle. The two o-rings or the axle seal one and the axle seal two are used to provide a seal to prevent liquids from leaking down through the first bucket base 494A. The overall shape of the bucket and the grinding tool 487A in connection with the use of the various blades, their placement and shape prevent food waste from being clumped up or having other problems in connection with processing.

FIG. 4L illustrates an example blade or paddle 488A of a grinding tool 487A with a facing surface 498A that as shown has a configuration that makes an approximately five degree angle relative to an interior surface or wall 499A of the bucket 110A. The angle can vary from two degrees to nine degrees with an optimal angle at five degrees. A benefit of the chosen angle is as the grinding mechanism rotates, the angle maintains movement or flow of the waste food during processing or the churn of the waste food as the food waste is pressed against the side walls and the teeth of the various levels of blades 480A, 481A, 482A. A fixed blade 486A in connection with the third paddle 490A also brakes up clumps of food waste during processing.

Lower surface 495A on the paddle 488A illustrates another feature. This is shown in FIG. 4N as well. A cavity or indentation on the lower portions of the paddle 488A is defined by the lower surface 495A which leaves an opening in the grinding tool 487A for food waste to actually avoid being moved or touched by the paddle 488A as the paddle rotates. The benefit of this structure or the larger cavity defined by the lower surface 495A is that it can help in a processing cycle to enable food waste to churn and not get clumped up at any particular location in the bucket 110A. A height of the cavity defined by the surface 495A can be about equal to a narrowest portion of the paddle 488A.

FIG. 4M illustrates a top view of a paddle 488A of the grinding tool 487A in a bucket 110A. The sets of blades 480A, 481A, 482A are shown from the top view. A facing surface 496A of a fixed tooth 485A is shown relative to the facing surface 498A of the paddle 488A. Feature 497A represents the angle made by the facing surface 496A relative to the facing surface 498A. The angle can be defined by a tangential line of the facing surface 498A of the paddle 488A at a middle point along the facing surface 496A of the fixed tooth 485A. In one example, this angle can be between two degrees and ten degrees. One example optimal angle is a five degree angle. The purpose of constructing the rotating blade edge or paddle 488A and the fixed tooth 485A is to help push fibers of food waste being processed off the fixed tooth 485A. Note that a distal end portion of the fixed tooth 485A curves near the end such that the distal end potion of the fixed tooth 485A will still cut food waste. The fixed tooth 485A is exemplary and in one aspect, other fixed teeth 483A, 484A have a similar configuration. In other aspects, different teeth on different sets of blades 480A, 481A, 482A can have different configurations for the respective fixed teeth 483A, 484A, 485A. FIG. 4M also illustrates the screws 413A that can be used to attach the sets of blades 480A, 481A, 482A to the shelfs or inner surface of the first bucket 110A.

FIG. 4N shows the cavity defined by the lower surface 495A of the paddle 488A. Note that paddle 488A and paddle 489B have different shapes. Paddle 488A is taller than paddle 489A and extends from about a top half of a central portion of the grinding tool 487A. Paddle 489A is connected along almost the entire surface of the central portion of the grinding tool 487A and has a lower surface near a floor of the first bucket 110A. In contrast, paddle 488A extends in an opposite direction from paddle 489A and its lower surface 495A curves quickly upward rather than running parallel to the floor of the first bucket 110A and thus creates a cavity under the top portion of the paddle 488A. Further, as noted above, the paddle 488A is taller and has a distal end 407A that extends above a first set of blades 480A configured on the first bucket 110A. The distal end 409A of paddle 489A may not in one aspect extend above the first set of blades 480A. This difference in height of the paddles can aid in preventing the clogging or bunching of food waste during a processing cycle. The notches in the paddles 488A, 489A can be complementary to the respective sets of blades 480A, 481A, 482A. The rotating screw 492A could be used to secure the grinding tool 487A to the first bucket 110A.

The system 100 processes food waste in one aspect by using or calculating an amount of torque experienced by the system. For example, if a bone gets caught between a fixed tooth 485A and the grinding tool 487A, it may damage the system 100 or more specially the motor or drive train. It is helpful in that scenario to reverse the motor to dislodge the food waste and avoid such damage. Torque on the paddles 488A, 489A can be calculated from a grinding motor's revolutions per minute. The control system 130 can include algorithms to have torque limiting values as a means of protecting the motor, drivetrain and grinding system. There are different methods of determining the torque. For example, strain gauges can be implemented, electrical current sensors and a mechanism sensor could be deployed to provide a torque value to the control system 130. The torque can be directly measured or calculated from another known value. The system 100 may also sense the characteristics of the food waste such as what type of food is in the first bucket 110A or other facts such as how full is the bucket 110A and based at least in part on such data can select a torque determining method. For example, a first method may be chosen if there is hard food waste such as bone while another method may be chosen for softer food waste like bread. The torque determining method or component may also be turned off during some cycles based on any number of parameters.

The system 100 can adjust/optimize key cycle parameters from various readings/data collected from sensors throughout the cycle from the beginning. A combination of these readings can be used to trigger the end of the cycle. In one example, the cycle can be optimized based on any combination of one or more of the following measurements: (1) Temperature at the bucket base (contact and non-contact sensors/methods); (2) Air temperatures; (3) Exhaust air temperature (once the vessel exhaust air reaches a specific temperature, the end of the cycle is reached, or a cool-down phase is started); (4) Weight (using strain gages/load cells to measure the weight during the cycle. If there is no change in weight for a sufficient time, the cycle ends, or a cool-down phase is started); (5) Humidity (the humidity of the air is measured, and if it has not changed for a sufficient period, or if it has reached a predetermined target % relative humidity or an absolute humidity value, the end of the cycle is reached, or a cool-down phase is started); (6) Torque (If the measured torque is low, then it would suggest the food waste has been grinded and dry. Torque can also be used to determine the blade rotation schedule. Low torque could indicate clumping food waste, so a blade rotation reversal would reduce clumping. Sustained high torque could indicate compacting of the food waste, so a blade rotation reversal would reduce compacting. Sudden high torque could indicate jamming of hard/tough food waste, so a blade rotation reversal would reduce jamming.); (7) Camera (visible/IR) (To see how much food has been processed or to see the temperature of the vessel or to see if the temperature of the food is homogenous; this would suggest thorough mixing and that higher heat-plate temperatures would be more effective at this point.); (8) Image processing (Image processing a picture of the food waste before and during processing the bucket, could determine food waste types, blade rotation schedule, cycle parameters such as heating, cooling, air flow rate.); (9) Water content (resistance), to determine food waste humidity, food waste contents, odors indicators (types, volatility); and (10) Motor torque measurement e.g., using the motor current draw to determine torque; Use motor RPM to determine torque). AC motors may be used rather than DC motors for the purpose of determining or calculating the torque on the system based on determining the revolutions per minute.

In one example, the system 100 can use image processing, machine learning or artificial intelligence such that trained models can be used to classify certain types of food waste and to predict how it will respond to processing within the first bucket 110A. The models could be trained on several different characteristics such as visual characteristics, processing characteristics, liquid density in the food waste, hardness (bone, bread, etc.) or other factors. The trained model could receive data from a camera or other sensor and classify the food waste, which output can then be used to determine what processing model or cycle to use. The parameters of the processing cycle could then be applied to more efficiently process the food. The system 100 can implement different cycles depending on various factors. For example, an “eco” cycle may be used, or if in a closed-loop configuration the system 100 may generate too much heat for a room in which the system 100 is in, and so forth. Different cycle profiles can be implemented manually or automatically based on a number of factors which can be based on one or more of such parameters as room temperature, energy usage for a cycle, type of system (closed-loop or open-loop), outside temperature, time of day, historical use, food waste weight or other characteristics, predicted future use of the system 100, and so forth. For example, if the first bucket 110A and the second bucket 110B are full and about to process food waste, and the system 100 predicts through a machine learning model or based on a cycle profile that an accelerated requirement for processing waste food is coming (the dinner hour of a restaurant is 45 minute away), then the system may choose a faster food processing cycle to get read for additional cycles.

In one aspect, there can be multiple processing modes (fast, eco, enzyme safe, etc.). The system 100 can features multiple processing modes by adjusting one or more parameters: heater temperature; processing air temperature; airflow; bucket rotation schedule (forward for a period of time, backwards for a period of time, etc.); and processing modes that are user selected. The processing modes can be independently determined for the respective processing compartments 106A/106B or in another aspect, the control system 130 may specifically coordinate the different cycles such that, for example, cycles that started at different times will end at the same time or approximately the same time. One cycle may use a relatively large amount of energy and the control system 130 may implement a low energy cycle in the other processing compartment to achieve an overall energy usage goal.

A drawer module with the grinding, heating, and condensation systems integrated together. This structure enables easy installation and replacement of one or more components if necessary.

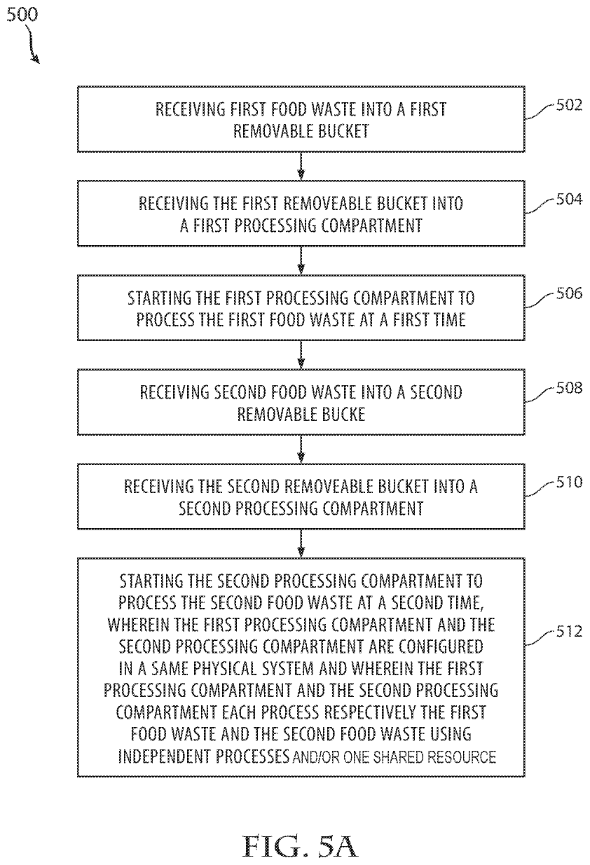

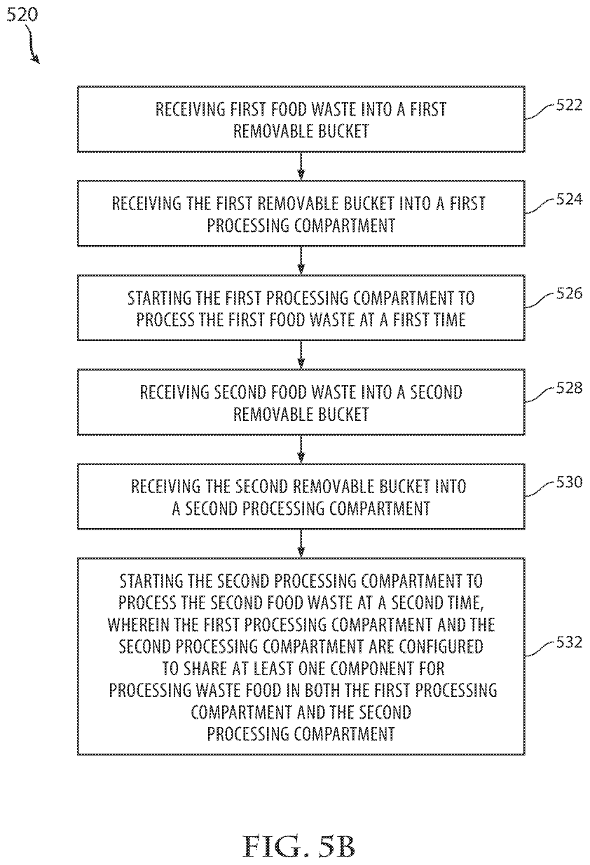

FIG. 5A illustrates an example method 500 for managing multiple processing compartments 106A/106B. The method can be performed by a system 100 includes a first processing compartment 106A for receiving a first bucket of first waste food, a first controller for controlling, via the first processing compartment, a first food recycling process for the first waste food, a second processing compartment 106B for receiving a second bucket of second waste food, a second controller for controlling, via the second processing compartment, a second food recycling process for the second waste food, and at least one condenser that processes first humid air from the first processing compartment and second humid air from the second processing compartment.

In some aspects, the method 500 can include controlling both the first processing compartment and the second processing compartment via at least one controller or at least one control system that is shared between them.

An example method 500 includes one or more steps of receiving first food waste into a first removable bucket (502), receiving the first removable bucket into a first processing compartment (504), starting the first processing compartment to process the first food waste at a first time (506), receiving second food waste into a second removable bucket (508), receiving the second removable bucket into a second processing compartment (510) and starting the second processing compartment to process the second food waste at a second time, wherein the first processing compartment and the second processing compartment are configured in a same physical system and wherein the first processing compartment and the second processing compartment each process respectively the first food waste and the second food waste using independent processes and/or with at least one shared component or resource (512). An example of a shared resource can be any of the components disclosed herein such as a heat pump or any sub-system thereof, a condenser, a power supply, a filter, a controller such as a master controller or control system, a drainage port, or any other component or group of components.

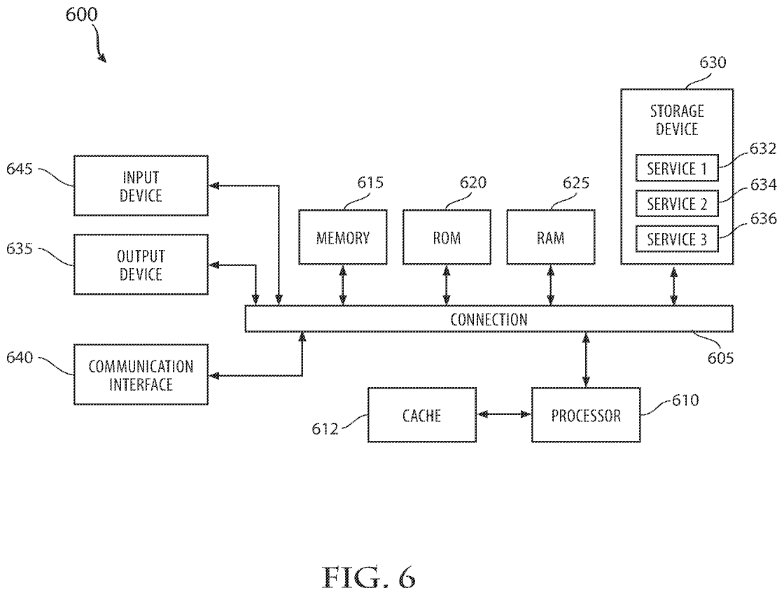

The first controller or first control system and the second controller or second control system can operate independently to process the first waste food and the second waste food respectively. The at least one condenser system can include a first condenser system 124A operating with the first processing compartment 106A and a second condenser system 124B operating with the second processing compartment 106B. In one aspect, a common control system 130 can control the different processing compartment processes separately. The control system 130 can include any one or more of the features of computing device 600 shown in FIG. 6.

The system 100 can include a first channel or first exhaust port 118A for moving the first humid air from the first processing compartment 106A to the at least one heat pump 122 and a second channel or second exhaust port 118B for moving the second humid air from the second processing compartment 106B to the at least one heat pump 122. The channels can have different configurations to accommodate the movement 128 of the respective processing compartments 106A/106B in and out of a stored position.

The heat pump 122 can also represent any component that is shared amongst the first processing compartment 109A and the second processing compartment 109B. For example, the feature 122 can represent one or more of a drain system, an exhaust port, a power system, a filter or odor control system, a control system, a master control that communicates and/or manages separately independent system controls configured with each of the first processing compartment 109A and the second processing compartment 109B, and/or any other shared component or combinations of shared components.

In one aspect, the first processing compartment 106A further includes a first motor 114A, a first fan, a first heater as an internal component 116A, a first lid 108A, and a first filter. The second processing compartment 106B can include a second motor 114B, a second fan, a second heater as an internal component 116B, a second lid 108B, and a second filter. The respective processing compartment 106A/106B can also include a respective heater 308A/308B.

FIG. 5B illustrates a method 520 related to processing waste food in a hybrid food cycler system. The method 520 can include one or more of receiving first food waste into a first removable bucket (522); receiving the first removable bucket into a first processing compartment (524); starting the first processing compartment to process the first food waste at a first time (526); receiving second food waste into a second removable bucket (528); receiving the second removable bucket into a second processing compartment (530); and starting the second processing compartment to process the second food waste at a second time, wherein the first processing compartment and the second processing compartment are configured to share at least one component for processing waste food in both the first processing compartment and the second processing compartment (532).

In some aspects, the at least one component can include one or more of a drain, a power supply, a filter, a controller, a master controller, a communication component and a heat pump. In some aspects, the heat pump can include at least a compressor, an evaporator and at least one condenser. The at least one condenser can include a first condenser configure to service the first processing compartment and a second condenser configure to service the second processing compartment.

In some aspects, the first processing compartment 109A can process the first food waste in a first food processing cycle that includes a forward airflow portion and a reverse airflow portion. The second processing compartment 109B can process the second food waste in a second food processing cycle that comprises the forward airflow portion and the reverse airflow portion. The reverse airflow portion of the cycle can be used to cool down components of the system as needed and may be turned on or off depending on sensor feedback such as a heat sensor that provided at to the control system 130 as part of a processing cycle. The reverse airflow portion thus can cool down the first removable bucket and/or the second removable bucket.

In some aspects, a first cycle to process the first waste food via the first processing compartment starting at the first time can include one or more of: using contact heating with the first removable bucket or using non-contact heating with the first removable bucket; causing air to flow in a first direction during a first portion of the first cycle; and causing air to flow in a reverse direction in a second portion of the first cycle.

Similarly, a second cycle to process the second waste food via the second processing compartment starting at the second time (which does not have to be the same process as the first cycle above) can include one or more of: using contact heating with the second removable bucket or using non-contact heating with the second removable bucket; causing air to flow in the first direction during a first portion of the second cycle; and causing air to flow in the reverse direction in a second portion of the first cycle.

Most of the examples above involve a first processing compartment 109A and a second processing compartment 109B but the concepts can further include more than two processing compartments to yield a group of processing compartments in which at least two processing compartments of the group of processing compartments have at least one shared component as described herein, such as one or more of a heat pump, power supply, control system, communication component, condenser, and so forth.

In some aspects, a system can include a first processing compartment 109A configured to receive first food waste into a first removable bucket and configured to start processing the first food waste, via the first processing compartment, at a first time; a second processing compartment 109B configured to receive second food waste into a second removable bucket and configured to start processing the second food waste, via the second processing compartment, at a second time; and at least one component that is shared for processing waste food in both the first processing compartment and the second processing compartment.

In some aspects, the at least one component can include one or more of a drain, a power supply, a filter or odor control system, a controller, a master controller, a communication component and a heat pump. The heat pump can include at least a compressor, an evaporator and at least one condenser. The at least one condenser can include a first condenser configure to service the first processing compartment and a second condenser configure to service the second processing compartment.

FIG. 6 is a diagram illustrating an example of a system for implementing certain aspects of the present technology. In particular, FIG. 6 illustrates an example of computing system 600, which may be for example any computing device making up internal computing system, a remote computing system, a camera (or any visual or other capturing mechanism that captures electromagnetic signals), or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some aspects, computing system 600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.6 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some aspects, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. Note that the system 100 itself can be considered modular. System 100 can be interconnected with other systems 100 physically and/or wirelessly. Systems 100 can be connected physically together through shared exhaust/odor systems, drain systems, heat pump and/or control boards. The system 100 can be connected wireless through WiFi, Bluetooth, or any wireless protocol or any wireless link between two compute devices each associated with a respective system 100 or component of the system 100.

Claim clauses of the disclosure include:

Clause 1. A system comprising: a first processing compartment for receiving a first bucket of first waste food; at least one controller; a second processing compartment for receiving a second bucket of second waste food, wherein the at least one controller controls, via the first processing compartment, a first food recycling process for the first waste food and controls, via the second processing compartment, a second food recycling process for the second waste food;

and at least one heat pump that processes first humid air from the first processing compartment and second humid air from the second processing compartment.

Clause 2. The system of clause 1, wherein the at least one controller controls the independent processing of the first waste food and second waste food whether it done directly or whether it comprises a first controller and a second controller that operate independently to process the first waste food and the second waste food respectively.

Clause 3. The system of clause 1 or any previous clause, wherein the at least one heat pump comprises a first condenser system operating with the first processing compartment and a second condenser system operating with the second processing compartment.

Clause 4. The system of clause 1 or any previous clause, further comprising: a first channel for moving the first humid air from the first processing compartment to the at least one heat pump; and a second channel for moving the second humid air from the second processing compartment to the at least one heat pump.

Clause 5. The system of clause 1 or any previous clause, wherein the system is configured under a counter-top and/or is approximately 18 inches wide.

Clause 6. The system of clause 1 or any previous clause, wherein: the first processing compartment is configured to be pulled in a horizontal direction to enable ingress and egress of the first bucket; and the second processing compartment is configured to be pulled in the horizontal direction to enable ingress and egress of the second bucket.

Clause 7. The system of clause 1 or any previous clause, wherein the first processing compartment further comprises a first motor, a first fan, a first heater, a first lid, and a first filter and wherein the second processing compartment comprise a second motor, a second fan, a second heater, a second lid, and a second filter.

Clause 8. The system of clause 1 or any previous clause, further comprising: a first heater in the first processing compartment; and a second heater in the second processing compartment.

Clause 9. The system of clause 1 or any previous clause, wherein the first bucket has a volume of 10-15 liters and wherein the second bucket has a volume of 10-15 liters.

Clause 10. The system of clause 1 or any previous clause, wherein the system has a housing volume comprising 150-250 liters.

Clause 11. A system comprising: a first processing compartment for receiving a first bucket of first waste food; a second processing compartment for receiving a second bucket of second waste food; and at least one heat pump that processes first humid air from the first processing compartment and second humid air from the second processing compartment wherein the first processing compartment and the second processing compartment recycle the first waste food and the second waste food on independent recycling processes.

Clause 12. The system of clause 11, further comprising: at least one controller for controlling, via the first processing compartment, a first food recycling process for the first waste food and for controlling, via the second processing compartment, a second food recycling process for the second waste food.

Clause 13. The system of clause 12 or any previous clause, wherein the at least one controller further comprises: a first controller for controlling, via the first processing compartment, the first food recycling process for the first waste food; and a second controller for controlling, via the second processing compartment, the second food recycling process for the second waste food.

Clause 14. The system of clause 11 or any previous clause, wherein the first processing compartment is configured to move horizontally on a first sliding bracket.

Clause 15. The system of clause 14 or any previous clause, wherein the first processing compartment comprises a first motor, a first filter, a first heater, a first lid, and a first fan configured as a first unit that moves horizontally on the first sliding bracket.

Clause 16. The system of clause 11 or any previous clause, wherein the second processing compartment is configured to move horizontally on a second sliding bracket.

Clause 17. The system of clause 16 or any previous clause, wherein the second processing compartment comprises a second motor, a second filter, a second heater, a second lid, and a second fan configured as a second unit that moves horizontally on the second sliding bracket.

Clause 18. The system of clause 11 or any previous clause, wherein the first processing compartment comprises a first air channel that transmits the first humid air to the at least one heat pump and wherein the second processing compartment comprises a second air channel that transmits the second humid air to the at least one heat pump.

Clause 19. The system of clause 18 or any previous clause, wherein the first air channel is established when the first processing compartment is in a closed position and wherein the second air channel is established when the second processing compartment is in the closed position.

Clause 20. A method comprising: receiving first food waste into a first removable bucket; receiving the first removable bucket into a first processing compartment; starting the first processing compartment to process the first food waste at a first time; receiving second food waste into a second removable bucket; receiving the second removable bucket into a second processing compartment; and starting the second processing compartment to process the second food waste at a second time, wherein the first processing compartment and the second processing compartment are configured in a same physical system and wherein the first processing compartment and the second processing compartment each process respectively the first food waste and the second food waste using independent processes and/or at least one shared resource.

Clause 21. A non-transitory computer-readable storage medium, the non-transitory computer-readable storage medium including instructions that when executed by a computer, cause the computer to: receive first food waste into a first removable bucket; receive the first removable bucket into a first processing compartment; start the first processing compartment to process the first food waste at a first time; receive second food waste into a second removable bucket; receive the second removable bucket into a second processing compartment; start the second processing compartment to process the second food waste at a second time, wherein the first processing compartment and the second processing compartment are configured in a same physical system and wherein the first processing compartment and the second processing compartment each process respectively the first food waste and the second food waste using independent processes and/or at least one shared resource.

Clause 22. The non-transitory computer-readable storage medium of clause 21, the non-transitory computer-readable storage medium including instructions that when executed by a computer, cause the computer to: manage via one or more controllers the first processing compartment and the second processing compartment including at least one shared component between the first processing compartment and the second processing compartment.

Clause 23. A computing apparatus comprising: a processor; and a memory storing instructions that, when executed by the processor, configure the computing apparatus to: receive first food waste into a first removable bucket; receive the first removable bucket into a first processing compartment; start the first processing compartment to process the first food waste at a first time; receive second food waste into a second removable bucket; receive the second removable bucket into a second processing compartment; and start the second processing compartment to process the second food waste at a second time, wherein the first processing compartment and the second processing compartment are configured in a same physical system and wherein the first processing compartment and the second processing compartment each process respectively the first food waste and the second food waste using independent processes and/or at least one shared resource.

Clause 24. A system comprising: a first processing compartment for receiving a first bucket of first waste food; a second processing compartment for receiving a second bucket of second waste food; at least one controller for controlling, via the first processing compartment, a first food recycling process for the first waste food and controlling, via the second processing compartment, a second food recycling process for the second waste food; and at least one heat pump that processes first humid air from the first processing compartment and second humid air from the second processing compartment.

Clause 25. The system of clause 24, wherein the at least one heat pump comprises a single heat pump that is shared between the first processing compartment and the second processing compartment.

Clause 26. The system of clause 24 or any previous clause, wherein at least one component used for processing waste food is shared in the system between the first processing compartment and the second processing compartment.

Clause 27. The system of clause 24 or any previous clause, wherein a volumetric efficiency of 0.070 to 0.140 associated with a ratio of a first volume of the first bucket and the second bucket relative to a second volume of the system.

Clause 28. The system of clause 24 or any previous clause, wherein a volumetric efficiency of the system between a first volume of the first bucket and the second bucket relative to a second volume of the system is at or around 0.106.

Clause 29. A hybrid multiple food cycler system comprising: a housing having a first volume; a first processing compartment for receiving a first bucket of first waste food, the first processing compartment configured within the housing; a first controller for controlling, via the first processing compartment, a first food recycling process for the first waste food; a second processing compartment for receiving a second bucket of second waste food, the second processing compartment configured within the housing and wherein a second volume is associated with both the first bucket and the second bucket; at least one controller for controlling, via the first processing compartment, a first food recycling process for the first waste food and controlling, via the second processing compartment, a second food recycling process for the second waste food; and at least one heat pump configured within the housing and that processes first humid air from the first processing compartment and second humid air from the second processing compartment.

Clause 30. The hybrid multiple food cycler system of clause 29, wherein a volumetric efficiency ratio between the second volume and the first volume comprises about 0.106.

Clause 31. The hybrid multiple food cycler system of clause 29 or any previous clause, wherein the first bucket has a first grinding tool and a first grinding tool with a first surface angle that make about a five degree angle with a first side surface of the first bucket.

Clause 32. The hybrid multiple food cycler system of clause 29 or any previous clause, wherein the first bucket has a first grinding tool and a first grinding tool with a first surface angle that make between a two degree angle and a nine degree angle with a first side surface of a respective tooth in a set of blades configured on a lower interior surface of the first bucket.

Clause 33. The hybrid multiple food cycler system of clause 29 or any previous clause, wherein the first bucket comprises first sets of blades configured on an interior surface of the first bucket and secured by first screws configured to screw downward into the interior surface of the first bucket and wherein the second bucket comprises second sets of blades configured on an interior surface of the second bucket and secure by second screws configured to screw downward into the interior surface of the second bucket.

Clause 34. The hybrid multiple food cycler system of clause 29 or any previous clause, wherein at least one component used for processing waste food is shared in the hybrid multiple food recycler system between the first processing compartment and the second processing compartment.

Clause 35. A food cycler system comprising: a housing having a first volume; a first processing compartment for receiving a first bucket of first waste food, the first processing compartment configured within the housing; a controller for controlling, via the first processing compartment, a first food recycling process for the first waste food; a second processing compartment for receiving a second bucket of second waste food, the second processing compartment configured within the housing and wherein a second volume is associated with both the first bucket and the second bucket, wherein the controller controls, via the second processing compartment, a second food recycling process for the second waste food; and at least one heat pump configured within the housing and that processes first humid air from the first processing compartment and second humid air from the second processing compartment.

Clause 36. A method comprising: receiving first food waste into a first removable bucket; receiving the first removable bucket into a first processing compartment; starting the first processing compartment to process the first food waste at a first time; receiving second food waste into a second removable bucket; receiving the second removable bucket into a second processing compartment; and starting the second processing compartment to process the second food waste at a second time, wherein the first processing compartment and the second processing compartment are configured to share at least one component is shared for processing waste food in both the first processing compartment and the second processing compartment.

Clause 37. The method of clause 36, wherein the at least one component comprises one or more of a drain, a power supply, a filter, a controller, a master controller, a communication component and a heat pump.

Clause 38. The method of clause 37 or any previous clause, wherein the heat pump comprises at least a compressor, an evaporator and at least one condenser.

Clause 39. The method of clause 38 or any previous clause, wherein the at least one condenser comprises a first condenser configure to service the first processing compartment and a second condenser configure to service the second processing compartment.

Clause 40. The method of clause 36 or any previous clause, wherein the first processing compartment communicates with the second processing compartment via a wireless communication link.

Clause 41. The method of clause 36 or any previous clause, further comprising: processing the first food waste in the first processing compartment in a first food processing cycle that comprises a forward airflow portion and a reverse airflow portion; and processing the second food waste in the first processing compartment in a second food processing cycle that comprises the forward airflow portion and the reverse airflow portion.

Clause 42. The method of clause 41 or any previous clause, wherein the reverse airflow portion cools down the first removable bucket and the second removable bucket.

Clause 43. The method of clause 36 or any previous clause, wherein a first cycle to process the first waste food via the first processing compartment starting at the first time comprises one or more of: using contact heating with the first removable bucket; using non-contact heating with the first removable bucket; causing air to flow in a first direction during a first portion of the first cycle; and causing air to flow in a reverse direction in a second portion of the first cycle.

Clause 44. The method of clause 43 or any previous clause, wherein a second cycle to process the second waste food via the second processing compartment starting at the second time comprises one or more of: using contact heating with the second removable bucket; using non-contact heating with the second removable bucket; causing air to flow in the first direction during a first portion of the second cycle; and causing air to flow in the reverse direction in a second portion of the first cycle.

Clause 45. A system comprising: a first processing compartment configured to receive first food waste into a first removable bucket and configured to start processing the first food waste, via the first processing compartment, at a first time; a second processing compartment configured to receive second food waste into a second removable bucket and configured to start processing the second food waste, via the second processing compartment, at a second time; and at least one component that is shared for processing waste food in both the first processing compartment and the second processing compartment.

Clause 46. The system of clause 45 or any previous clause, wherein the at least one component comprises one or more of a drain, a power supply, a filter, a controller, a master controller, a communication component and a heat pump.

Clause 47. The system of clause 46 or any previous clause, wherein the heat pump comprises at least a compressor, an evaporator and at least one condenser.

Clause 48. The system of clause 47 or any previous clause, wherein the at least one condenser comprises a first condenser configure to service the first processing compartment and a second condenser configure to service the second processing compartment.

Clause 49. The system of clause 45 or any previous clause, wherein the first processing compartment communicates with the second processing compartment via a wireless communication link.

Clause 50. The system of clause 45 or any previous clause, wherein: the first processing compartment processes the first food waste in a first food processing cycle that comprises a forward airflow portion and a reverse airflow portion; and the second processing compartment processes the second food waste in a second food processing cycle that comprises the forward airflow portion and the reverse airflow portion.

Clause 51. The system of clause 50 or any previous clause, wherein the reverse airflow portion cools down the first removable bucket and the second removable bucket.

Clause 52. The system of clause 45 or any previous clause, wherein a first cycle to process the first waste food via the first processing compartment starting at the first time comprises one or more of: using contact heating with the first removable bucket; using non-contact heating with the first removable bucket; causing air to flow in a first direction during a first portion of the first cycle; and causing air to flow in a reverse direction in a second portion of the first cycle.

Clause 53. The system of clause 52 or any previous clause, wherein a second cycle to process the second waste food via the second processing compartment starting at the second time comprises one or more of: using contact heating with the second removable bucket; using non-contact heating with the second removable bucket; causing air to flow in the first direction during a first portion of the second cycle; and causing air to flow in the reverse direction in a second portion of the first cycle.

Clause 54. A system comprising one or more: means for receiving first food waste into a first removable bucket; means for receiving the first removable bucket into a first processing compartment; means for starting the first processing compartment to process the first food waste at a first time; means for receiving second food waste into a second removable bucket; means for receiving the second removable bucket into a second processing compartment; and means for starting the second processing compartment to process the second food waste at a second time, wherein the first processing compartment and the second processing compartment are configured to share at least one component for processing waste food in both the first processing compartment and the second processing compartment.

Clause 55. A computer-readable storage device storing instructions for controlling at least one processor, wherein the instructions cause the at least one processor to be configured to: receive first food waste into a first removable bucket; receive the first removable bucket into a first processing compartment; start the first processing compartment to process the first food waste at a first time; receive second food waste into a second removable bucket; receive the second removable bucket into a second processing compartment; and start the second processing compartment to process the second food waste at a second time, wherein the first processing compartment and the second processing compartment are configured to share at least one component for processing waste food in both the first processing compartment and the second processing compartment.

What is claimed is:

1. A system comprising:
a first processing compartment for receiving a first bucket of first waste food;
at least one controller;
a second processing compartment for receiving a second bucket of second waste food, wherein the at least one controller controls, via the first processing compartment, a first food recycling process for the first waste food and controls, via the second processing compartment, a second food recycling process for the second waste food; and
at least one heat pump that processes first humid air from the first processing compartment and second humid air from the second processing compartment.

2. The system of claim 1, wherein the at least one controller comprises a first controller and a second controller that operate independently to process the first waste food and the second waste food, respectively.

3. The system of claim 1, wherein the at least one heat pump comprises a first condenser system operating with the first processing compartment and a second condenser system operating with the second processing compartment.

4. The system of claim 1, further comprising:
a first channel for moving the first humid air from the first processing compartment to the at least one heat pump; and
a second channel for moving the second humid air from the second processing compartment to the at least one heat pump.

5. The system of claim 1, wherein the system is configured under a counter-top and/or is approximately 18 inches wide.

6. The system of claim 1, wherein:
the first processing compartment is configured to be pulled in a horizontal direction to enable ingress and egress of the first bucket; and
the second processing compartment is configured to be pulled in the horizontal direction to enable ingress and egress of the second bucket.

7. The system of claim 1, wherein the first processing compartment further comprises a first motor, a first fan, a first heater, a first lid, and a first filter and wherein the second processing compartment comprise a second motor, a second fan, a second heater, a second lid, and a second filter.

8. The system of claim 1, further comprising:
a first heater in the first processing compartment; and
a second heater in the second processing compartment.

9. The system of claim 1, wherein the first bucket has a volume of 10-15 liters and wherein the second bucket has a volume of 10-15 liters.

10. The system of claim 1, wherein the system has a housing volume comprising 150-250 liters.

11. A system comprising:
a first processing compartment for receiving a first bucket of first waste food;
a second processing compartment for receiving a second bucket of second waste food; and
at least one heat pump that processes first humid air from the first processing compartment and second humid air from the second processing compartment wherein the first processing compartment and the second processing compartment recycle the first waste food and the second waste food on independent recycling processes.

12. The system of claim 11, further comprising:
at least one controller for controlling, via the first processing compartment, a first food recycling process for the first waste food and for controlling, via the second processing compartment, a second food recycling process for the second waste food.

13. The system of claim 12, wherein the at least one controller further comprises:
a first controller for controlling, via the first processing compartment, the first food recycling process for the first waste food; and
a second controller for controlling, via the second processing compartment, the second food recycling process for the second waste food.

14. The system of claim 11, wherein the first processing compartment is configured to move horizontally on a first sliding bracket.

15. The system of claim 14, wherein the first processing compartment comprises a first motor, a first filter, a first heater, a first lid, and a first fan configured as a first unit that moves horizontally on the first sliding bracket.

16. The system of claim 11, wherein the second processing compartment is configured to move horizontally on a second sliding bracket.

17. The system of claim 16, wherein the second processing compartment comprises a second motor, a second filter, a second heater, a second lid, and a second fan configured as a second unit that moves horizontally on the second sliding bracket.

18. The system of claim 11, wherein the first processing compartment comprises a first air channel that transmits the first humid air to the at least one heat pump and wherein the second processing compartment comprises a second air channel that transmits the second humid air to the at least one heat pump.

19. The system of claim 18, wherein the first air channel is established when the first processing compartment is in a closed position and wherein the second air channel is established when the second processing compartment is in the closed position.

20. A method comprising:
receiving first food waste into a first removable bucket;
receiving the first removable bucket into a first processing compartment;
starting the first processing compartment to process the first food waste at a first time;
receiving second food waste into a second removable bucket;
receiving the second removable bucket into a second processing compartment; and
starting the second processing compartment to process the second food waste at a second time, wherein the first processing compartment and the second processing compartment are configured in a same physical system and wherein the first processing compartment and the second processing compartment each process respectively the first food waste and the second food waste using independent processes and at least one shared resource.
